(19) United States
(12) Patent Application Publication
(10) Pub. No.: US 2021/0124163 A1
(43) Pub. Date: Apr. 29, 2021

(54) INTEGRATED OPTICAL SWITCHING AND SPLITTING FOR OPTICAL NETWORKS

(71) Applicant: COMMSCOPE TECHNOLOGIES LLC, Hickory, NC (US)

(72) Inventors: Salvatore TUCCIO, Kessel-Lo (BE); Jan WATTÉ, Grimbergen (BE); Cristina LERMA ARCE, Gent (BE)

(73) Assignee: COMMSCOPE TECHNOLOGIES LLC, Hickory, NC (US)

(21) Appl. No.: 16/638,705

(22) PCT Filed: Aug. 16, 2018
(86) PCT No.: PCT/US2018/000187

§ 371 Date: Feb. 12, 2020

Related U.S. Application Data
(60) Provisional application No. 62/546,410, filed on Aug. 16, 2017.

(51) Int. Cl. G02B 26/00; G02F 1/313; H04Q 11/00

(52) U.S. Cl. CPC G02B 26/005; G02F 1/313; H04Q 2011/0039; H04Q 2011/0015; H04Q 11/0005

(57) ABSTRACT

An optical circuit that has a first input waveguide, at least a first output waveguide and an optical path between the first input waveguide and the at least a first output waveguide. A first totally internally reflecting (TIR) waveguide switch lies on the optical path between the first input waveguide and the at least a first output waveguide. A wavelength selective filter is disposed on the optical path between the first input waveguide and the at least one output waveguide, the wavelength selective filter being transmissive for light in a first wavelength range and reflective for light in a second wavelength range.

### CROSS-REFERENCE TO RELATED APPLICATION

This application is being filed on Aug. 16, 2018 as a PCT International Patent Application and claims the benefit of U.S. Patent Application Ser. No. 62/546,410, filed on Aug. 16, 2017, the disclosure of which is incorporated herein by reference in its entirety.

### BACKGROUND OF THE INVENTION

The present invention is generally directed to optical transmission networks, and more particularly to systems that permit flexible configuration of optical components in the field.

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

FIG. 1 illustrates one embodiment of a network 100 deploying fiber optic lines. In the illustrated embodiment, the network 100 can include a central office 101 that connects a number of end subscribers 105 (also called end users 105 herein) in a network. The central office 101 can additionally connect to a larger network such as the Internet (not shown) and a public switched telephone network (PSTN). The network 100 can also include fiber distribution hubs (FDHs) 103 that distribute signals to the end users 105. The various lines of the network 100 can be aerial or housed within underground conduits.

The portion of the network 100 that is closest to central office 101 is generally referred to as the F1 region, where F1 is the “feeder fiber” from the central office 101. The portion of the network 100 closest to the end users 105 can be referred to as an F2 portion of network 100. The network 100 includes a plurality of break-out locations 102 at which branch cables are separated out from the main cable lines. Branch cables are often connected to drop terminals 104 that include connector interfaces for facilitating coupling of the fibers of the branch cables to a plurality of different subscriber locations 105.

An FDH 103 receives signals from the central office 101 via an input fiber. The incoming signal may be split at the FDH 103, using one or more optical splitters (e.g., 1×8 splitters, 1×16 splitters, or 1×32 splitters) to generate different user signals that are directed to the individual end users 105. In typical applications, an optical splitter is provided prepackaged in an optical splitter module housing and provided with a splitter output in pigtails that extend from the module. The optical splitter module provides protective packaging for the optical splitter components in the housing and thus provides for easy handling for otherwise fragile splitter components. This modular approach allows optical splitter modules to be added incrementally to FDHs 103 as required.

The number of end users may change, however, for example through the addition of new customers to the network or by customers dropping out of the network, and so occasions arise where the splitter in the FDH 103 may need to be replaced. In the case where more customers are added to the network, a splitter may need to be replaced by one having more outputs, for example a 1×16 splitter may need replacing by a 1×32 splitter. In other situations, for example where the number of customers drops, it may be useful to replace a splitter with one having fewer outputs. The replacement of a splitter at an FDH 103 requires that a technician travel to the FDH 103 to physically swap out the splitter. This can be costly and time-consuming. Also, a technician visit may be necessary when taking other actions, such as switching over to more OLTs when the number of customers increases, or when switching users between different service levels, such as different bitrates or video channels.

Furthermore, the splitters that are conventionally used in optical networks are passive devices whose configuration cannot be changed, which can lead to difficulties in monitoring the performance of the optical network. For example, one way of tracking down the cause of a signal loss at one or more end users is to use optical time-domain reflectometry (OTDR), which involves transmitting a pulsed optical signal along the fiber. Breaks, cracks or other issues with the fiber can result in a portion of the optical pulse being reflected to the source of optical pulses. The arrival times of the reflected pulses can be recorded and the time-of-flight measurement can be correlated with the position in the fiber where the reflection occurred. If there is a problem with transmission of signals to a particular end user, a technician has to set up the OTDR equipment downstream of the splitter output in the FDH 103 in order to isolate the end user's fiber from other fibers. This requires that the technician travels to the FDH 103 and physically disconnects the end user's fiber from the splitter in order to initiate the OTDR measurements. Again, this can be costly and time-consuming.

Therefore, there is a need for remote access to the FDH for changing the configuration of the splitter to add or drop fibers to end users, or to reconfigure the optical network to allow monitoring of one or more end users' fibers.

### SUMMARY OF THE INVENTION

One embodiment of the invention is directed to an optical circuit that has a first input waveguide, at least a first output waveguide and an optical path between the first input waveguide and the at least a first output waveguide. A first totally internally reflecting (TIR) waveguide switch, such as a TIR electro-wetting on dielectric (EWOD) switch, lies on the optical path between the first input waveguide and the at least a first output waveguide. A wavelength selective filter is disposed on the optical path between the first input waveguide and the at least one output waveguide, the wavelength selective filter being transmissive for light in a first wavelength range and reflective for light in a second wavelength range.

Another embodiment of the invention is directed to an optical circuit that includes a first wavelength pass/drop unit comprising an input coupled to a first TIR optical switch, a first output from the first TIR optical switch is coupled to a first wavelength selective filter, and an output from the wavelength selective filter comprises a first output of the first wavelength pass/drop unit. A second output from the first TIR optical switch is coupled as a first input to a second TIR optical switch, a second output from the first wavelength selective filter is coupled as a second input to the second TIR optical switch, and an output from the second TIR optical switch comprises a second output from the first wavelength pass/drop unit. A second wavelength pass/drop unit comprises an input coupled to a third TIR optical switch, a first output from the third TIR optical switch coupling to a second wavelength selective filter, and an output from the second wavelength selective filter comprises a first output of the second wavelength pass/drop unit output. A second output from the third TIR optical switch is coupled as a first input to a fourth TIR optical switch, a second output from the second wavelength selective filter is coupled as a second input to the fourth TIR optical switch, and an output from the fourth TIR optical switch comprises a second output of the second wavelength pass/drop unit. The second output of the first wavelength pass/drop unit is coupled as the input to the third TIR optical switch of the second wavelength pass/drop unit.

Another embodiment of the invention is directed to an optical circuit that has a first wavelength pass/drop unit comprising an input coupled to a first TIR optical switch, a first output from the first TIR optical switch is coupled to a first wavelength selective filter, a second output from the first TIR optical switch is coupled as a first input to a second TIR optical switch, an output from the first wavelength selective filter is coupled as a second input to the second TIR optical switch, and an output from the second TIR optical switch comprises an output from the first wavelength pass/drop unit coupled to a first end user. The optical circuit also has a second wavelength pass/drop unit that includes an input coupled to a third TIR optical switch, a first output from the third TIR optical switch coupled to a second wavelength selective filter, a second output from the third TIR optical switch coupled as a first input to a fourth TIR optical switch, an output from the second wavelength selective filter coupled as a second input to the fourth TIR optical switch, and an output from the fourth TIR optical switch comprising an output of the second wavelength pass/drop unit coupled to a second end user. The first and second wavelength pass/drop units receive respective optical signals from an optical splitter, the respective optical signals each comprising an optical signal in a first wavelength band and an optical signal in a second wavelength band. When the first wavelength pass/drop unit is in a first state, the output from the first wavelength pass/drop unit coupled to the first end user carries an optical signal in the first wavelength band only and when the first wavelength pass/drop unit is in a second state, the output from the first wavelength pass/drop unit coupled to the first end user carries optical signals in both the first and second wavelength bands.

Another embodiment of the invention is directed to an optical circuit having a selectable output. The optical circuit includes a first input coupled to receive a first optical signal and a first intermediate optical circuit coupled to the first input. The first intermediate circuit has first and second intermediate circuit outputs. The first intermediate circuit has a first state and a second state. The first intermediate circuit directs the first optical signal only to the first intermediate circuit output when in the first state and directs a first portion of the first optical signal to the first intermediate circuit output and a second portion of the first optical signal to the second intermediate circuit output when in the second state. The circuit includes a second input coupled to receive a second optical signal. A second intermediate optical circuit is coupled to the second input. The second intermediate circuit has third and fourth intermediate circuit outputs. The second intermediate circuit has a first state and a second state. When in the first state, the second intermediate circuit directs the second optical signal only to the fourth intermediate circuit output. When in the second state, the second intermediate circuit directs a first portion of the second optical signal to the fourth intermediate circuit output and a second portion of the second optical signal to the third intermediate circuit output.

Another embodiment of the invention is directed to a tunable optical splitter circuit having a first basic splitting circuit that includes a first input to receive a first input optical signal and a first switchable optical circuit coupled to receive the input optical signal from the first input. The first switchable optical circuit has first, second, third and fourth outputs. The switchable optical circuit has an input splitter stage that splits the first input optical signal into first and second input signal portions. The first switchable optical circuit comprises a switchable first intermediate circuit that either directs substantially all of the first input signal portion to the first output or splits the first input signal portion between the first and second outputs. It also includes a switchable second intermediate circuit that either directs substantially all of the second input signal portion to the fourth output or splits the second input signal portion between the third and fourth outputs.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates various elements of an optical data distribution and communication network;

FIG. 2 schematically illustrates an embodiment of elements of a fiber distribution hub according to an embodiment of the present invention;

FIGS. 3A and 3B schematically illustrate an embodiment of a pair of two totally internally reflecting (TIR) electrowetting-on-dielectric (EWOD) optical switches in a first pair of switch states, according to an embodiment of the present invention;

FIGS. 3C and 3D schematically illustrate the embodiment of the pair of two totally internally reflecting (TIR) electrowetting-on-dielectric (EWOD) optical switches in a second pair of switch states, according to an embodiment of the present invention;

FIG. 4 schematically illustrates an embodiment of a waveguide y-branch coupler;

FIG. 5 schematically illustrates an embodiment of a wavelength-dependent reflector unit;

FIGS. 6A and 6B schematically illustrate an embodiment of a switched splitter circuit, according to an embodiment of the present invention;

FIG. 7A schematically illustrates an embodiment of a wavelength band switching circuit, according to an embodiment of the present invention;

FIG. 7B schematically illustrates a wavelength band naming convention used in the specification;

FIGS. 7C and 7D schematically illustrate the embodiment of wavelength band switching circuit of FIG. 7A using different switch configurations, according to an embodiment of the present invention;

FIGS. 7E and 7F schematically illustrate another embodiment of a wavelength band switching circuit with the optical switches in different configurations, according to an embodiment of the present invention;

FIG. 7G schematically illustrates another embodiment of a wavelength band switching circuit with the optical switches in a first configuration, according to an embodiment of the present invention;

FIG. 7H schematically illustrates a wavelength band naming convention used in the specification;

FIG. 7I schematically illustrates another wavelength band naming convention used in the specification;

FIG. 7J schematically illustrates the embodiment of wavelength band switching circuit of FIG. 7G with the optical switches in a second configuration, according to an embodiment of the present invention;

FIGS. 8A and 8B schematically illustrate an embodiment of a wavelength pass/drop unit, according to an embodiment of the present invention;

FIG. 8C schematically illustrates an optical circuit employing cascaded wavelength pass/drop units according to an embodiment of the present invention;

FIG. 8D schematically illustrates an optical circuit having multiple parallel wavelength pass/drop units according to an embodiment of the present invention;

FIGS. 9A-9D schematically illustrate various states of an embodiment of a tunable splitter circuit, according to the present invention;

FIGS. 9E and 9F schematically illustrate various states of another embodiment of a tunable splitter circuit, according to the present invention FIGS. 9G and 9H schematically illustrate various states of another embodiment of a tunable splitter circuit, according to the present invention;

FIG. 10A-10D schematically illustrate various states of another embodiment of a tunable splitter circuit, according to the present invention;

FIGS. 11A and 11B schematically illustrate various states of another embodiment of a tunable splitter circuit according to the present invention;

FIGS. 12A-12C schematically illustrate various states of an embodiment of a two-stage tunable splitter circuit according to the present invention; and

FIG. 13 schematically illustrates another embodiment of a tunable splitter optical circuit, according to the present invention.

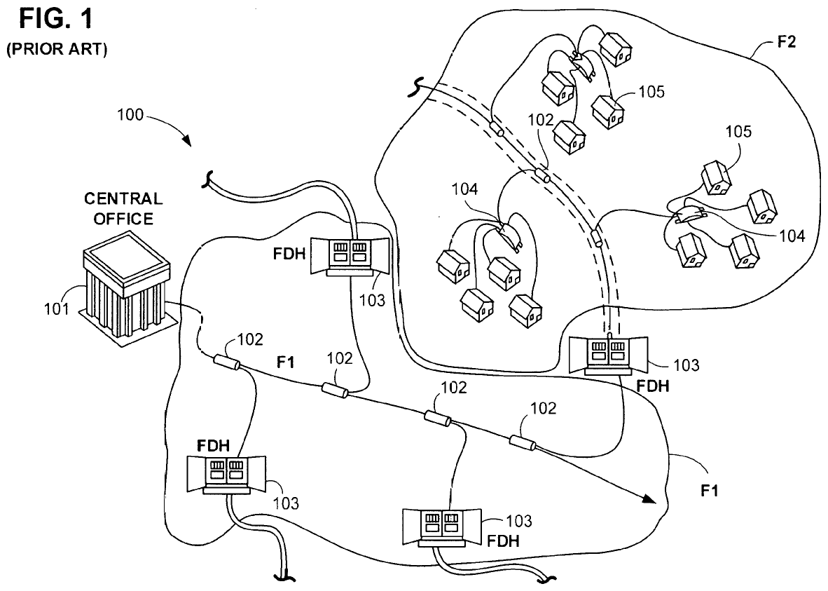

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to various optical devices and systems that can provide benefit in optical networks by providing for remote configuration, thus reducing the need for technician visits to a fiber distribution hub (FDH) and allowing various operations to be carried out more quickly than using conventional passive optical components.

In an illustrated embodiment of the invention, the optical network 100 includes a cable 110 that connects to an FDH 103. The cable 110 includes at least an optical data transmission fiber and an FDH control channel, which may be optical or electrical.

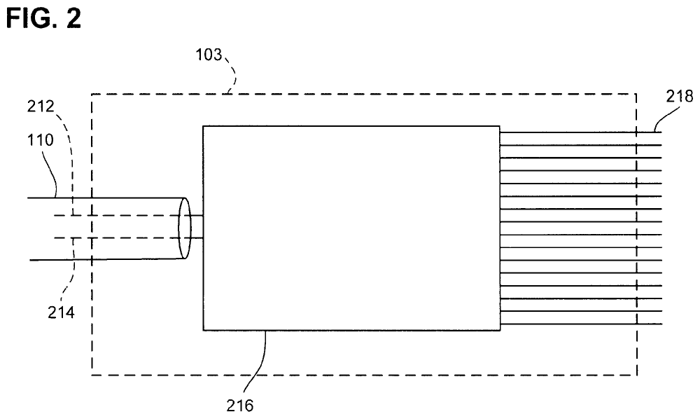

An illustrated embodiment of the FDH 103 and cable 110 is seen in greater detail in FIG. 2. The cable 110 entering the FDH 103 includes an optical data channel 212 and an FDH control channel 214. The optical data channel is typically one or more optical fibers and may include optical data transmission, such as cable television signals which are typically unidirectional in the fiber, and optical communications, for example internet traffic which are typically bidirectional in the fiber. The control channel 214 provides a control signal to the optical circuit 216 located within the FDH 103. The optical circuit 216 contains any optical elements that are used in the FDH 103 to distribute an optical signal to the end users 105. In the embodiments discussed below, the optical circuit contains total internal reflection (TIR) optical switches that are discussed in greater detail below, and various combinations of wavelength selective filters and y-branch couplers, although other optical elements typically used in optical data transmission networks may also be included on the optical circuit, such as amplifiers, optical circulators, and multiplexers. In the illustrated embodiment, the optical circuit 216 includes one or more splitters so that the optical signal is split into a number of different output channels 218 that are fed to end users 105. The output channels 218 may be optical channels, such as optical fibers, or may be electrical channels, for example coaxial electrical cables. In the case where the output channels 218 are electrical channels, the optical circuit 216 may also include optical-electrical converters for data transmission.

According to an embodiment of the present invention the optical circuit 216 includes one or more remotely-controlled TIR electro-wetting on dielectric (EWOD) optical switches that may be used, for example, to change the configuration of the optical circuit or the ratio of signal split into different output channels. An advantage of the microfluidic approaches of EWOD switching is that a microfluidically-controlled optical circuit can be manufactured on a glass substrate, which is relatively inexpensive, whereas an electro-optical approach to switching requires the use of electro-optic crystals that are more expensive than glass. A remotely-controllable optical circuit (RCOC) may, for example include one or more TIR switches, such as TIR EWOD switches, that can change a splitter system from a configuration having a first number of outputs to a splitter system having a second number of outputs. In another example of an RCOC, TIR optical switches are able to provide multiple levels of coupling between two waveguides, thus allowing a user to control the amount of light that is coupled from one waveguide into one or more other waveguides.

Other approaches to moving the index matching liquid in a TIR optical switch may be used in addition to EWOD approaches, for example approaches based on moving a liquid droplet based on thermally expanding or contracting an adjacent gas bubble, and the like, as are known in the art. Where a TIR switch does not depend on EWOD activation of the liquid, non-polar liquids may be employed, such as OCF (optical coupling fluid) 446 available from Nye Lubricants, Inc., Fairhaven, Mass., USA or MIRASIL® DM 100 (a linear polydimethylsiloxane fluid) available from Bluestar Silicones USA, East Brunswick, N.J., USA

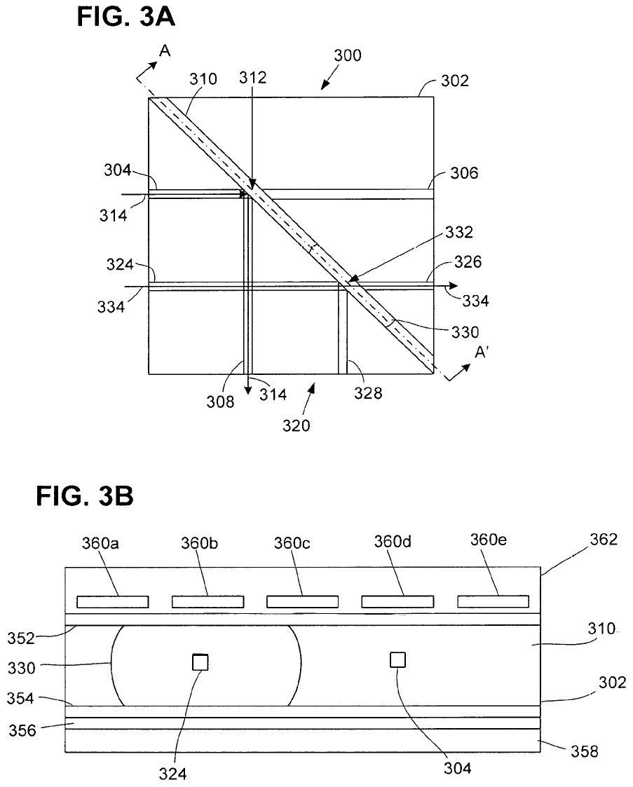

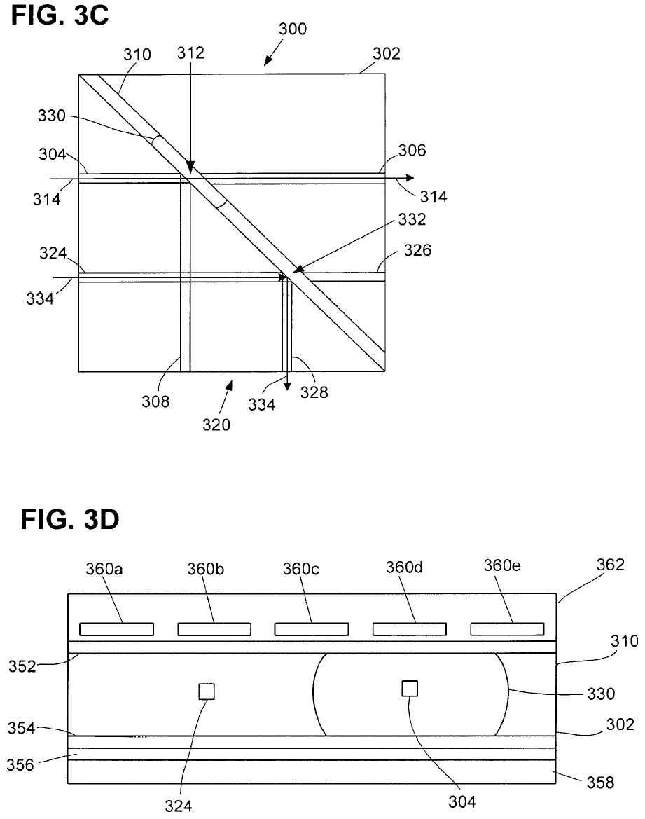

The optical circuits described herein use various combinations of three basic building blocks, the first of which is the TIR optical switch, which is discussed with reference to FIGS. 3A-3D. FIG. 3A shows a plan view of an embodiment of a TIR EWOD optical switch 300 in a first, reflective switch state. The switch 300 includes a first input waveguide 304, a first output waveguide 306 and a second output waveguide 308 on a waveguide 302. A channel 310 crosses the input waveguide 304 at a crosspoint 312. The channel 310 is substantially empty of optical material and may be formed in the substrate 302 using any suitable technique, e.g. photolithography and reactive ion etching (RIE). In many embodiments the channel 310 is mostly filled with air. The first output waveguide 306 is located across the channel 310 from the input waveguide.

In the illustrated embodiment, the channel 310 is empty at the crosspoint 312, so light 314 in the input waveguide 304 is total internally reflected at the wall of the channel 310 into the second output waveguide 308, hence this type of optical switch is referred to as a totally internally reflecting (TIR) optical switch.

The substrate 302 also includes a second TIR optical switch 320. In the illustrated embodiment the second TIR optical switch 320 is in a second, transmissive state. The second TIR optical switch 320 is formed with an input waveguide 324 terminating at the channel 310, a first output waveguide 326 across the channel 310 from the input waveguide 324, and a second output waveguide 328 that terminates at the channel 310 at a second crosspoint 332. A droplet 330 of liquid material is located within the channel 310 at the crosspoint 332. The refractive index of the liquid material is selected so that light 334 propagating along the first waveguide is incident on the wall of the channel 310 at an angle that does not result in total internal reflection at the wall of the channel 310. Accordingly, the light 334 propagates through the droplet 330 of liquid material and into the first output waveguide 326. Thus, a TIR optical switch can be in either of two states, a reflective state or a transmissive state, depending on whether the liquid material is present at its crosspoint.

Different liquids may be used as index-matching liquids in the channel 310. For example, when the TIR optical switch is an EWOD TIR optical switch, a liquid such as hydroxypropylene carbonate or propylene carbonate may be used. Additional liquids that may be used include preferably polar organic compounds such as methanol, ethanol, and other alcohols, ethylene glycol and propylene glycol, methyl formamide, or formamate, are discussed in U.S. Provisional Patent Application No. 62/393,463, titled “Liquids For Use With Electro-Wetting On Dielectric Active Optical Switch,” filed on Sep. 12, 2016, and incorporated herein by reference. Additionally, non-polar organic compounds may be used as the liquid in embodiments where the liquid is moved using an approach that does not involve the use of a polar compound. Examples include OCF (optical coupling fluid) 466 available from Nye Lubricants, Inc., Fairhaven, Mass., USA, and silicon-based liquids such as MIRASIL® DM 100 (a linear dimethylsiloxane fluid), available from Bluestar Silicones USA, East Brunswick N.J., USA.

It should be understood that the angle α between the input and second output waveguide may be selected to be any suitable angle, depending on various factors including, but not restricted to, the refractive indices of the waveguides, the waveguide numerical aperture, the refractive index of the liquid material and manufacturing tolerances. The value of α is 90° in the illustrated embodiment, but values smaller or greater than this value may also be selected that result in total internal reflection when the TIR optical switch is in the reflective state and transmission through the liquid material when it is present at the crosspoint.

The droplet 330 of liquid material may be moved along the channel 310 using an applied electro-wetting force, which results from the application of an electric field asymmetrically across the droplet 330. A cross-sectional view through the substrate 302, along line AA′, is shown in FIG. 3B. The cross-sectional view shows the ends of waveguides 304 and 324 terminating at the wall of the channel 310. The figure also shows the droplet 330 of liquid at the end of waveguide 324. The upper and lower surfaces 352, 354 of the channel 310 are provided with a dielectric coating, preferably a low surface energy dielectric coating such as PTFE or an alkyl silane, as described in U.S. Provisional Application No. 62/393,473, incorporated herein by reference. A ground electrode 356 is provided below the lower surface 354 and above a lower substrate layer 358. A number of individually addressable electrodes 360a, 360b, 360c, 360d, 360e may be positioned above the channel 310, in a cover layer 362. The droplet 330 is typically formed of a polar liquid that has a relatively high surface energy and may be, for example, water, acetonitrile, methanol, ethanol, propanol, propylene carbonate or hydroxy propylene carbonate, propionitrile, methylacetamide, an alkyl glycol such as ethylene glycol or propylene glycol, formamide, and the like, as well as various substituted versions of these materials and mixtures thereof.

The droplet 330 of liquid may be made to move via an electro-wetting force applied via the electrodes. The application of an electric field to an electro-wetting liquid reduces its surface energy. If the electric field is applied asymmetrically to only one side of a droplet of the liquid, the surface energy of that part of the droplet exposed to the electric field is reduced, resulting in the liquid droplet flowing to the side of the droplet of the applied electric field. Thus, the liquid droplet can be moved via sequential application of an electric field to electrode 360c, then electrode 360d and then electrode 360e. FIG. 3D shows a cross-sectional view of the resulting switch configuration, where the liquid droplet 330 has been moved from a first position at waveguide 324 to a second position at waveguide 304. A plan view of the switches 300, 320 in this second configuration is shown in FIG. 3C. The liquid droplet 330 is at the crosspoint of the first switch so the light 314 passes from the input waveguide 304 through the droplet 330 into the first output waveguide 306, while the light 334 is totally internally reflected at the wall of the channel 310 and along the second output waveguide 328.

Thus, a TIR optical switch has the following states:
Bar state (transmissive)—light is transmitted through the liquid to the opposite waveguide across the channel;
Cross state (reflective)—light is totally internally reflected at the channel wall to a second output guide on the same side of the channel as the input waveguide.

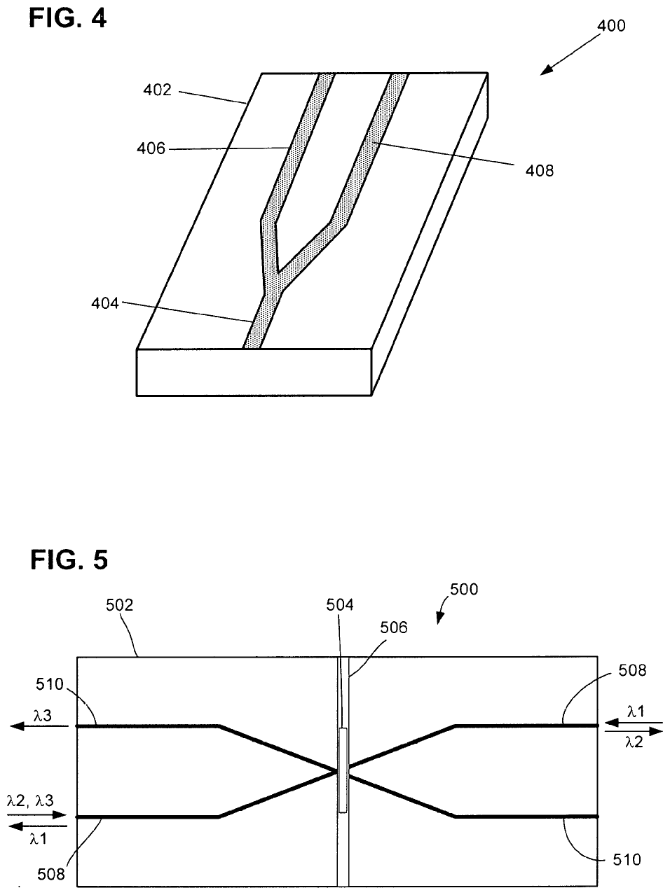

The second building block is a y-branch coupler, an exemplary embodiment of which is shown in FIG. 4. The y-branch coupler 400 is a waveguide coupler formed in a substrate 402. It includes an input waveguide 404 and two output waveguides 406, 408. Light entering the y-branch coupler 400 via the input waveguide 404 is split into two fractions, each one propagating along its respective output waveguide 406, 408. In some embodiments the y-branch coupler 400 is configured so that the optical power of light passing into each output waveguide 406, 408 is substantially equal, i.e. the input power is split into each output waveguide 50/50, in which case the y-branch coupler may be referred to as a 3 dB coupler. In other embodiments, the power in one of the output waveguides 406, 408 may be greater than in the other, depending on the design of the y-branch coupler 400. For example, the power ratio between the two output waveguides may be 40/60, 30/70, or any other desired ratio.

The third optical circuit building block is a wavelength-dependent reflector unit 500, an embodiment of which is schematically illustrated in FIG. 5. The wavelength-dependent reflector unit 500 includes a thin film filter 504 that is located in a slot 506 in the substrate 502. The thin film filter 504 typically includes a multilayer dielectric stack deposited on an optical substrate. The reflective properties of the thin film filter 504 are selected via the design of the multilayer dielectric stack and may be, for example, a low pass filter (passing light having a shorter wavelength while reflecting light having a higher wavelength), a high pass filter (passing light having a longer wavelength while reflecting light having a shorter wavelength), a notch filter (reflecting light within a specific wavelength band while passing light outside the wavelength band), a band pass filter (transmitting light within a specific wavelength band while reflecting light outside the wavelength band) or the like.

A first waveguide 508 and a second waveguide 510 are directed to cross at the surface of the thin film filter 504 that contains the multilayer dielectric stack. The slot 506 for the thin film filter 504 cuts across the waveguides 508, 510 and so is preferably thin, for example around 20 μm or less. In one embodiment, light at a first wavelength λ1 is injected into the right side of the first waveguide 508 while light at a second wavelength, λ2, and third wavelength, λ3, is injected into the left side of the first waveguide 508. In this embodiment, λ1<λ2, λ3, and the thin film filter 504 reflects light having a wavelength longer than λ2, i.e. operates as a short pass filter. Thus, the light at λ1 is transmitted through the thin film filter and propagates to the left side of the first waveguide 508, and the light at λ2 is transmitted through the thin film filter and propagates to the right side of the first waveguide 508. The light at λ3, however, is reflected by the thin film filter 504 and propagates along the left side of the second waveguide 510. In other embodiments, the thin film filter 504 may be a short pass filter having a shorter cutoff wavelength, e.g. having a cutoff wavelength between λ1 and λ2 so that it transmits light at λ1 while reflecting light at λ2 and λ3), or may be a high pass filter (e.g. transmitting light at λ3 while reflecting light at λ1 and λ2), a notch filter (e.g. transmitting light at λ1 and λ3, while reflecting light at λ2), or a bandpass filter (e.g. transmitting light at λ2, while reflecting light at λ1 and λ3).

The building block elements described above may be integrated into optical chips based on silica glass, e.g. PLC chips, using low index contrast or high index contrast waveguides. Low index contrast waveguides are typically easier to connect to via a pigtailed fiber as they have a relatively large core dimension. High index contrast waveguides, on the other hand, allow low-loss implementation of tighter fiber bends than low index contrast waveguides, and fiber pig-tailing can be accomplished via the use of spot-size converters. In PLC chips, the channel in a TIR optical switch and the slot in a wavelength-dependent reflector unit may be formed using an etching technique such as reactive ion etching (RIE), including deep reactive ion etching (DRIE).

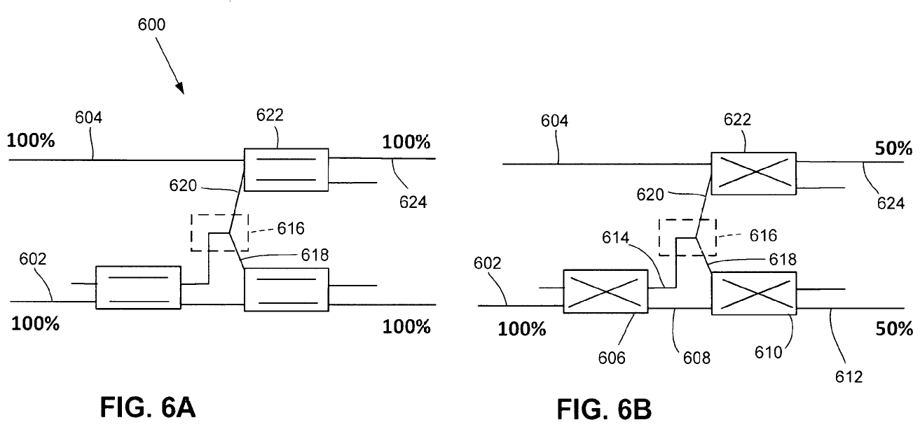

A first embodiment of an optical circuit, or part of an optical circuit, using these building blocks is schematically represented in FIGS. 6A and 6B. The optical circuit 600 operates as a switched optical splitter and includes a first input waveguide 602 and a second input waveguide 604. The first input waveguide 602 leads to a first TIR optical switch 606, such as a TIR EWOD optical switch. A first output 608 from the first TIR optical switch 606 leads to a second TIR optical switch 610. An output 612 leads out of the second TIR optical switch 610. A second output 614 from the first TIR optical switch 606 is an input to a y-branch coupler 616, which may be, but is not required to be, a 3 dB coupler. A first output 618 from the y-branch coupler 616 is connected as an input to the second TIR optical switch 610, and the second output 620 from the y-branch coupler 616 is coupled as an input to the third TIR optical switch 622. The second input waveguide 604 is coupled as the second input to the third TIR optical switch 622.

In the description provided herein, the optical circuits are implemented as waveguide circuits on a substrate. Thus, when the description refers to an “input” or an “output,” it should be understood that these terms respectively refer to a waveguide along which light propagates into a circuit element and a waveguide along which light propagates from a circuit element. It should also be appreciated that many optical circuits are reversible, in that light can propagate in a forward direction or in a backwards direction through an optical circuit. Accordingly, the present description, the terms “input” and “output” do not require that light propagate only in a single direction through the optical elements of the circuit. Instead, these terms are used to describe one of the directions of propagation through the optical circuit in order to help the reader understand how the optical circuit operates. For example, in one direction an optical splitter may be used to split an optical signal propagating along a single path into several optical signals propagating along respective paths. In reverse, the optical splitter will combine optical signals propagating along different paths into an optical signal propagating along one path.

In the embodiment illustrated in FIG. 6A, the three TIR optical switches 606, 610, 622 are all in the bar state. Thus, a signal that enters the first TIR optical switch 606 from the first input waveguide 602 is transmitted to the first output 608 and into the second TIR optical switch 610 and through to the output 612. Therefore, discounting switch and other transmission losses, 100% of the signal entering on the first input waveguide 602 is transmitted to the output waveguide 612. Furthermore, a signal propagating along the second input waveguide 604 is transmitted through the third TIR optical switch 622 to the output waveguide 624. Therefore, discounting transmission and switch losses, 100% of the signal entering on the second input waveguide 604 is transmitted to the output waveguide 624.

In the embodiment illustrated in FIG. 6B, the three TIR optical switches 606, 610, 622 are all in the cross state. Thus, a signal propagating along the first input waveguide 602 is transmitted via the first TIR optical switch 606 to the y-branch coupler. A portion of the signal is transmitted along the y-branch coupler output 618 to the second TIR optical switch 610, to the output waveguide 612. The other portion of the signal is transmitted along the second y-branch coupler output 620 to the third TIR optical switch 622 to the output waveguide 624. Thus, in this switch configuration, an optical signal input along the first input waveguide 602 is split between the two output waveguides 612, 624 in a ratio dependent on the splitting ratio of the y-branch coupler 616. In the case where the y-branch coupler is a 3 dB coupler, the input signal is split 50/50 between the two output waveguides 612, 624, as shown in the figure. Thus, the circuit 600 can operate as a splitter when the switches are in the cross state and as a pass device when the switches are in the bar state.

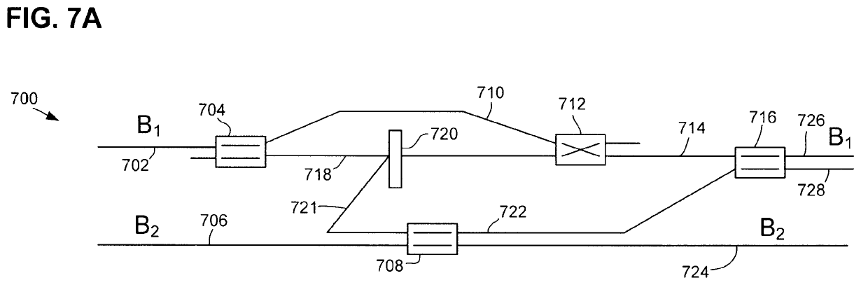

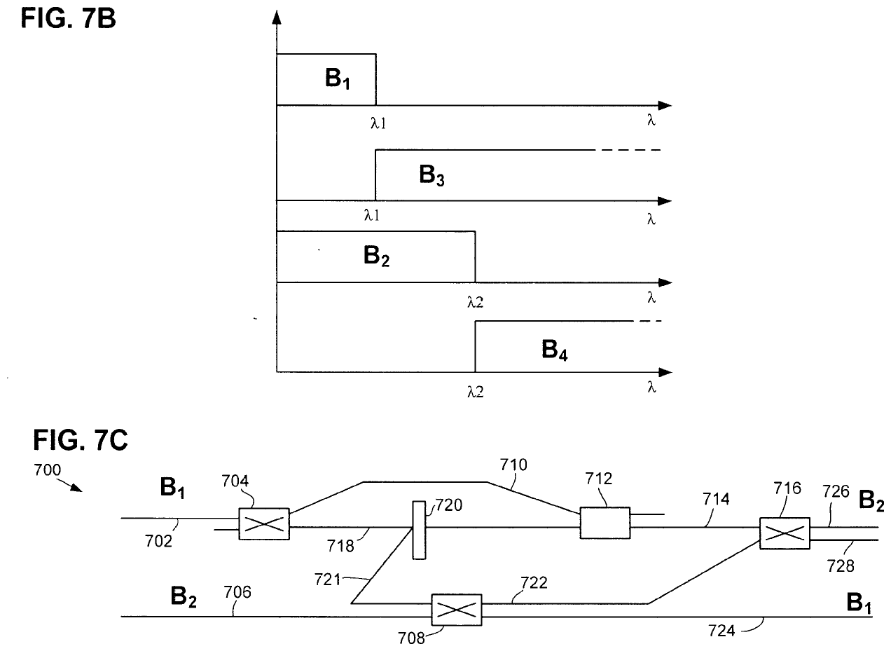

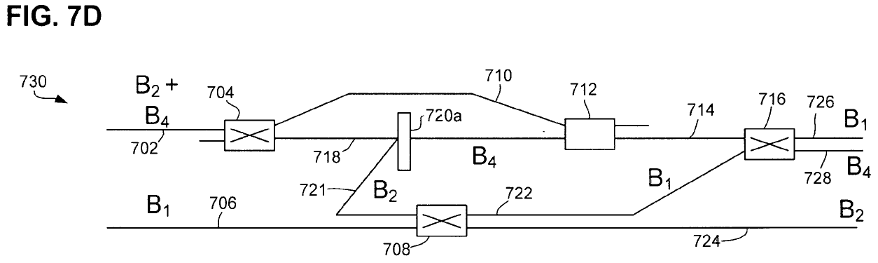

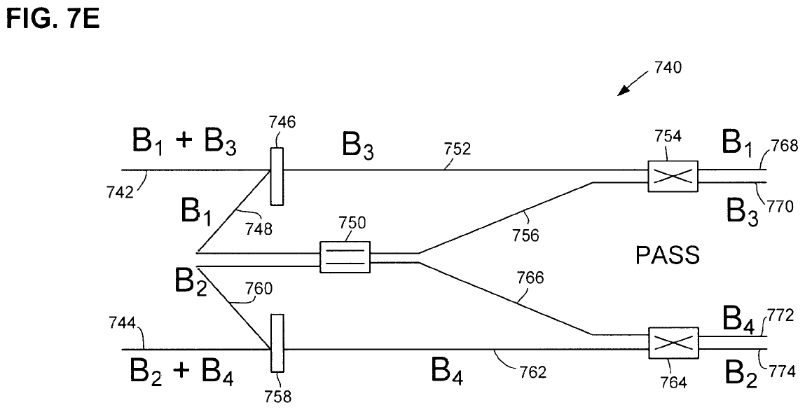

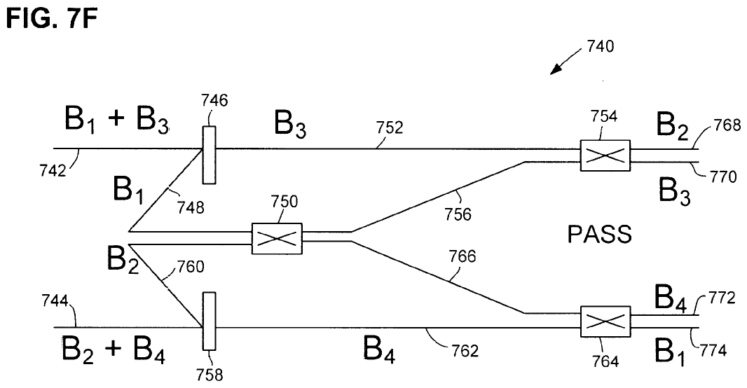

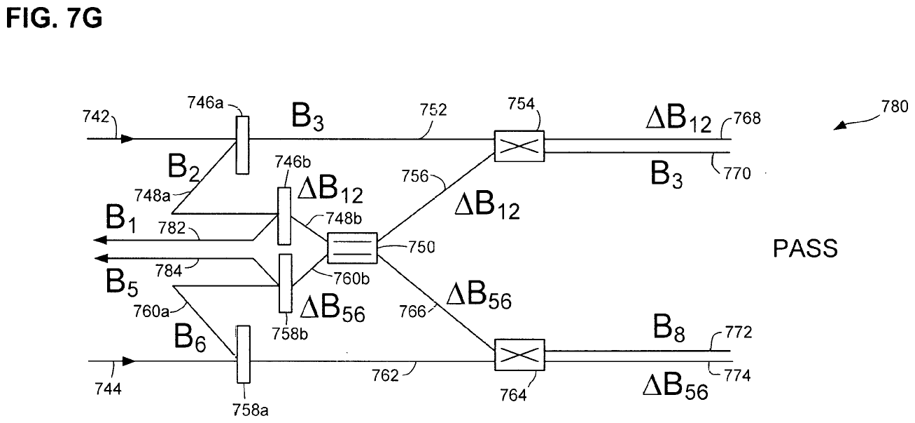

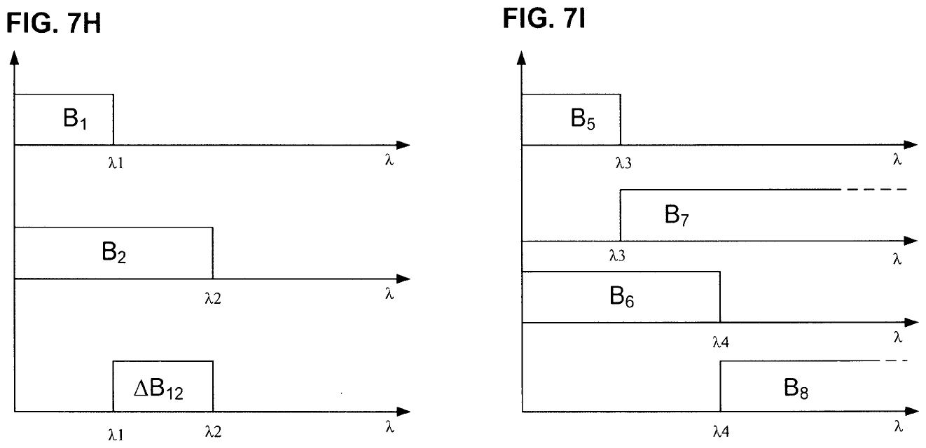

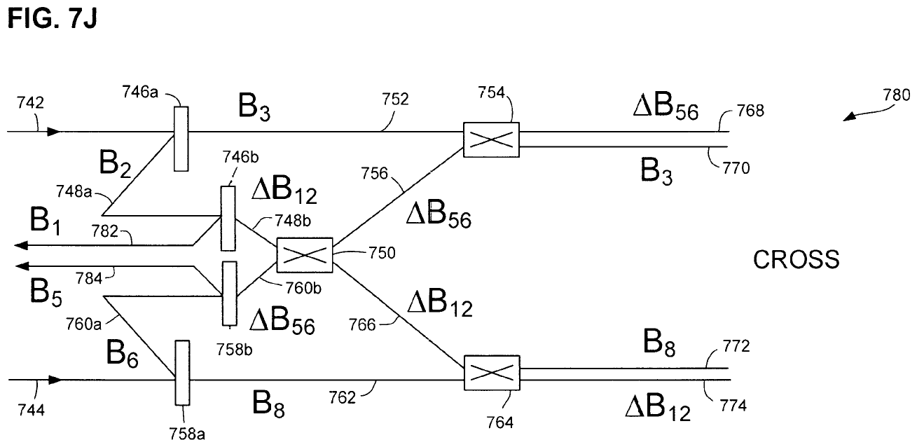

Another embodiment of an optical circuit 700, which operates as a wavelength band switch, is schematically illustrated in FIGS. 7A, 7C and 7D. A first input waveguide 702 feeds light to a first optical switch 704 and a second input waveguide 706 feeds light into an input of a second optical switch 708. Light passing along the first input waveguide into the first optical switch 704 is output along a first switch output waveguide 710 when the first optical switch is in the bar state. The first switch output waveguide 710 is fed as an input to a third optical switch 712. When the third optical switch 712 is in the cross state, light passing along the first switch output waveguide 710 is directed to the third switch output waveguide 714, which is an input to the fourth optical switch 716.

A second output 718 from the first optical switch 704 is directed to a first wavelength selective reflector unit 720, which reflects light having a wavelength up to around 1. Light having a wavelength of up to around 1 is referred to as being in band 131, see FIG. 7B. It is understood that an optical filter typically has a reflectivity curve that changes from low reflectivity to high reflectivity over a finite wavelength range, for example over a range of a few nanometers. In the discussion here, the wavelength λ represents the value of wavelength at which the reflectivity of the wavelength selective reflector unit is midway between the high and low values. Therefore, the wavelength selective reflector unit is said to reflect light up to around a value of i.e. light in Band B₁. Light having a wavelength of around λ1 and greater is referred to as being in band B₃.

Light having wavelength of up to around λ2, where λ2 is longer than is referred to as being in band B₂ while light having a wavelength of greater than around λ2 is referred to as being in band B₄. Thus, when a light signal containing light having a wavelength component greater than λ1 and a wavelength component less than λ1 is incident on the first wavelength selective reflector unit 720, only light having a wavelength of up to around λ1, i.e. light in band B1, is reflected while light in band B2 is transmitted.

The light reflected from the first wavelength selective reflector unit 720 is directed along path 721 as a second input to the second optical switch 708. A first output 722 of the second optical switch 708 is coupled as a second input to the fourth optical switch 716. A second output 724 of the second optical switch 708 may be used as a second circuit output. When the fourth optical switch 716 is in the bar state, the optical signal on the third switch output waveguide 714 is directed to the output waveguide 726.

FIG. 7A shows the optical circuit 700 in a first configuration, with the first, second and fourth TIR optical switches 704, 708 and 716 in the bar state and the third TIR optical switch 712 in the cross state. In this circuit configuration, an optical signal in band B₁ propagating along the first input waveguide 702 is directed along the first switch output waveguide 710 to the third optical switch 712, which is passed along the third switch output waveguide 714 to the fourth optical switch 716 and along the first circuit output 726. Light propagating in band B₂, propagating along the second input waveguide 706, passes through the second optical switch 708 and along the second circuit output 724.

FIG. 7C shows the same circuit and same signals on input waveguides 702 and 706 as shown in FIG. 7A except, in this circuit configuration, the first, second and fourth optical switches 704, 708 and 716 are in the cross state. Consequently, the signal at band B₁ now appears at the second circuit output 724 and the signal at band B₂ appears at the first circuit output 726. The third optical switch 712 is shown blank, indicating that it can be in either the bar or cross state without affecting the outputs of the circuit 700.

FIG. 7D shows a similar optical circuit 730 but, in this configuration, light in band B₁ is directed along the second circuit input 706, while the signal propagating along the first circuit input 702 contains wavelength components both greater than and less than λ2 and is hence shown as containing both B₂ and B₄. In this optical circuit 730 the first wavelength selective reflector unit 720a reflects light having a wavelength of no more than about λ2, i.e. light in band B₂, and transmits light having a wavelength of more than about λ2, i.e. light in band B₄. The first, second and fourth optical switches 704, 708 and 716 are in the cross state while the third optical switch 712 is in the bar state. As a result, the optical signal appearing at the first circuit output 726 is B1, the optical signal appearing at the second circuit output 724 is B₂ and light in band B₄ appears at the third circuit output 728, which is an output from the fourth optical switch 716.

Another embodiment of wavelength selector circuit 740 is schematically illustrated in FIGS. 7E and 7F. The circuit 740 has first and second circuit inputs 742, 744. The first circuit input 742 is coupled to a first wavelength selective reflector unit 746. Light reflected by the first wavelength selective reflector unit 746 is directed along path 748 as a first input to a first TIR optical switch 750. Light transmitted through the first wavelength selective reflector unit 746 propagates along path 752 as a first input to a second optical switch 754. A first output 756 from the first TIR optical switch 750 is coupled as a second input to the second TIR optical switch 754.

The second circuit input 744 is coupled to a second wavelength selective reflector unit 758. Light reflected by the second wavelength selective reflector unit 758 is directed along path 760 as a second input to the first TIR optical switch 750. Light transmitted through the second wavelength selective reflector unit 758 propagates along path 762 as a first input to a third TIR optical switch 764. A second output 766 from the first TIR optical switch 750 is coupled as a second input to the third TIR optical switch 764. First and second circuit outputs 768, 770 are coupled to receive light signals from the second TIR optical switch 754, while third and fourth circuit outputs 772, 774 are coupled to receive light signals from the third TIR optical switch 764.

In the illustrated embodiment, the first wavelength selective reflector unit 744 reflects light having a wavelength of no more than about 1, i.e. reflects light in band B₁, and transmits light in band B₃. Thus, if light having wavelength components both greater than and less than λ1 is incident along the first circuit input 742, then light in band B₁ is directed to the first optical switch 750 along path 748 and light in band B₃ is directed along path 752 to the second optical switch 754. Also, the second wavelength selective reflector unit 758 reflects light having a wavelength of no more than about λ2, i.e. reflects light in band B₂, and transmits light in band B₄. Thus, if light having wavelength components both greater than and less than λ2 is incident along the second circuit input 744, then light in band B₂ is directed to the first TIR optical switch 750 along path 760 and light in band B₄ is directed along path 764 to the third TIR optical switch 764.

In the circuit configuration illustrated in FIG. 7E, the first TIR optical switch 750 is in the bar state, so the signal in band B₁ propagating along path 748 is directed along path 756 to the second TIR optical switch 754, while the signal in band B₂ propagating to the first TIR optical switch 750 along path 760 is directed along path 766 to the third TIR optical switch 764. The second TIR optical switch 754 is in the cross state, so the signal in band B₁ propagating along path 756 is directed to the first circuit output 768 while the signal in band B₃ propagating along path 752 is directed to the second circuit output 770. The third TIR optical switch 764 is also in the cross state, so the signal in band B₂ propagating along path 766 is directed to the fourth circuit output 774 while the signal in band B₄ propagating along path 762 is directed to the third circuit output 772.

FIG. 7F shows the optical circuit 740 with a different switch configuration. In this embodiment, the first TIR optical switch 750 is in the cross state, with the result that the signal in band B₂ appears at the first circuit output 768 and the optical signal in band B₁ appears at the fourth circuit output 774.

It will be appreciated that other configurations of this circuit may be employed. For example, changing the second TIR optical switch 754 from the cross state to the bar state will result in swapping the optical signals appearing at the first and second circuit outputs 768, 770.

Another optical circuit 780 is schematically presented in FIG. 7G. An optical signal enters the circuit along the first input waveguide 742 to a first wavelength selective reflector unit 746a. In this embodiment, the first wavelength selective reflector unit 746a reflects light having a wavelength less than λ2, so light in band B₃ propagates along the transmitted output path 752 from the first wavelength selective reflector unit 746a as an input to the second TIR optical switch 754. The light reflected along path 748a from the first wavelength selective reflector unit 746a is in band B₂ and is directed to a second wavelength selective reflector unit 746b. The second wavelength selective reflector unit 746b reflects light having a wavelength less than λ1, i.e. light in band B₁, along path 782. Light transmitted by the second wavelength selective reflector unit 746b along path 748b lies in the wavelength band between about λ1 and λ2, and is designated as being in band ΔB₁₂. FIG. 7H schematically shows the relationships among bands B₁, B₂ and ΔB₁₂.

In the illustrated embodiment, the first optical switch 750 is in the bar state, and so the light propagating along path 748b into the first optical switch 750 is directed along the first optical switch first output 756 to a second input to the second switch 754. The second optical switch 754 is in the cross state, so the light in band B₃, entering the first input to the second optical switch 754 is directed to the second circuit output 770, and the light in band ΔB₁₂, propagating along path 756 is directed to the first circuit output 768.

FIG. 7I schematically illustrates an additional set of wavelength bands, relating to wavelengths λ3 and λ4. In some embodiments, λ3 may be the same as λ1 or as λ2. In other embodiments, λ3 is not the same as either λ1 or λ2. In some embodiments, λ4 may be the same as λ1 or as λ2. In other embodiments, λ4 is not the same as either λ1 or λ2. Band B₅ covers light having a wavelength up to around λ3, while band B₆ covers light having a wavelength of longer than about λ3. Band B₇ covers light having a wavelength up to around λ4, while band B₈ covers light having a wavelength of longer than about λ4.

Another light signal enters the optical circuit 780 along the second circuit input 744 to the third wavelength selective reflector unit 758a. In this embodiment, the third wavelength selective reflector unit 758a reflects light having a wavelength less than λ4, so light in band B₈ propagates along the transmitted output path 762 from the third wavelength selective reflector unit 758a as an input to the third TIR optical switch 764. The light reflected along path 760a from the third wavelength selective reflector unit 758a is in band B₆ and is directed to a fourth wavelength selective reflector unit 758b. The second wavelength selective reflector unit 758b reflects light having a wavelength less than about λ3, i.e. light in band B₅, along path 784. Light transmitted by the fourth wavelength selective reflector unit 758b along path 760b lies in the wavelength band between about λ3 and λ4, and is designated as being in band ΔB₅₆.

In the illustrated embodiment, the first TIR optical switch 750 is in the bar state, and so the light propagating along path 760b, in band ΔB₅₆. into the first optical switch 750 is directed along the first optical switch second output 766 to a second input to the third TIR optical switch 764. The third TIR optical switch 764 is in the cross state, so the light in band B₈, entering the second input to the third optical switch 764 is directed to the third circuit output 772, and the light in band ΔB₅₆, propagating along path 766, is directed to the fourth circuit output 774. In this switch configuration, the optical circuit 780 may be said to be in a “pass state,” as light in the wavelength band ΔB₁₂, which entered along the upper half of the circuit 780, passes along the upper half of the circuit 780. Also, light in the wavelength band ΔB₅₆, which entered along the lower half of the circuit 780, passes along the lower half of the circuit 780.

FIG. 7J schematically illustrates the circuit 780 in a different switch configuration. Specifically, the first TIR optical switch 750 is in the cross state. Consequently, the light in wavelength band ΔB₁₂, exits the first TIR optical switch 750 along path 766 to the third TIR optical switch 764, and exits the circuit along the fourth circuit output 774. Also, light in wavelength band ΔB₅₆, exits the first TIR optical switch 750 along path 756 to the second TIR optical switch 754, and exits the circuit 780 along the first circuit output 768. This circuit configuration can be labeled the circuit's “cross” state.

It will be appreciated that other configurations of the circuit 780 may be employed. For example, changing the second optical switch 754 from the cross state to the bar state will result in swapping the optical signals appearing at the first and second circuit outputs 768, 770.

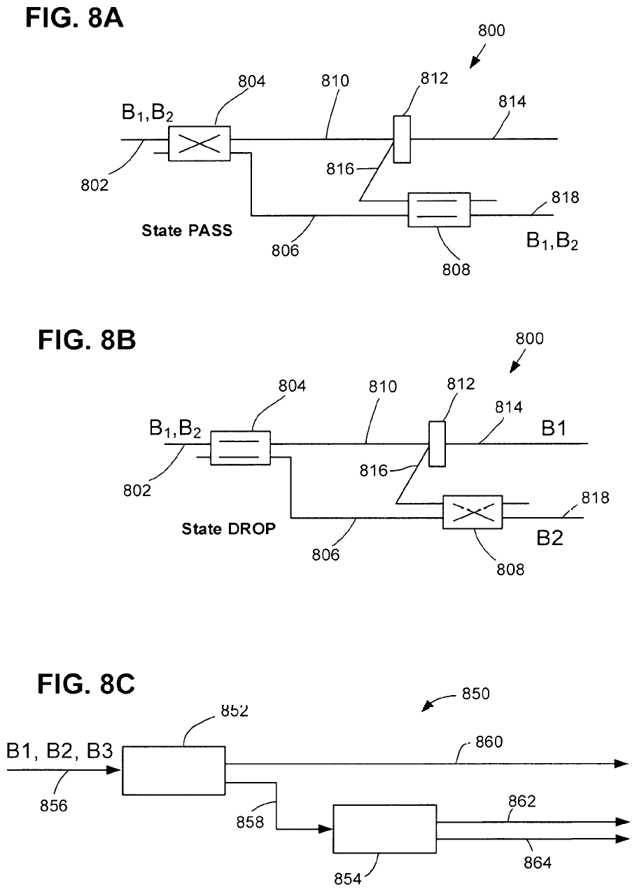

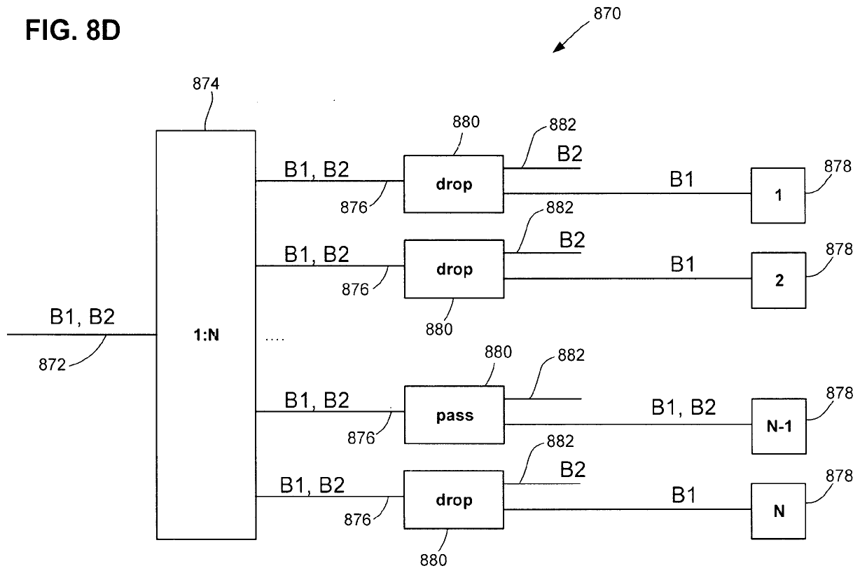

An optical circuit 800 that operates as a wavelength pass drop unit is schematically illustrated in FIGS. 8A and 8B. The circuit 800 has an input waveguide 802 coupled as an input to a first TIR optical switch 804. One of the outputs 806 from the first TIR optical switch 804 is coupled as an input to a second TIR optical switch 808. The other output 810 from the first TIR optical switch 804 is coupled to a wavelength-selective reflector unit 812 that transmits light in a first wavelength band, B1, and reflects light in a second wavelength band, B2. The path taken by light transmitted through the wavelength-selective reflector unit 812 is a first output 814 of the circuit 800. Light reflected by the wavelength-selective reflector unit 812 is directed as a second input 816 to the second TIR optical switch 808. One of the outputs from the second TIR optical switch 808 is used as the second circuit output 818.

In the embodiment illustrated in FIG. 8A, the switches are configured such that the first TIR optical switch 804 is in the cross state and the second TIR optical switch 808 is in the bar state. Accordingly, when an optical signal containing light in both the wavelength bands B1, B2 is input along the input waveguide 802 to the first TIR optical switch 804, the optical signal is substantially entirely directed to the second TIR optical switch 808, and is transmitted through the second TIR optical switch 808 along the second circuit output waveguide 818. Thus, in this switch configuration, the components of the optical signal in different wavelength bands are not separated from each other.

In the embodiment illustrated in FIG. 8B, the switches are configured such that the first TIR optical switch 804 is in the bar state and the second TIR optical switch 808 is in the cross state. Accordingly, the optical signal containing light in both wavelength bands B1, B2 is transmitted through the first TIR optical switch 804 to the wavelength-selective reflector unit 812, which transmits light in the wavelength band B1 and reflects light in the wavelength band B2. The reflected optical signal in the wavelength band B2 is directed to the second TIR optical switch 808, where it is directed to the second circuit output waveguide 818. The optical signal in the wavelength band B1, transmitted by the wavelength-selective reflector unit 812, is output along the first circuit output waveguide 814. Thus, the optical circuit operates as an optical pass/drop circuit, passing optical signals at both wavelength bands in one state and dropping the signal at B1 from the optical signal at B2 in the other state.

The optical circuit 800 may be repeatedly used in a cascaded fashion to provide switchable separation of multiple wavelength bands. For example, an optical circuit 850 shown in FIG. 8C employs a first wavelength pass/drop unit 852 and a second wavelength pass/drop unit 854. An optical signal containing light in three different wavelength bands B1, B2, B3 is input via an input waveguide 856 to the first wavelength pass/drop unit 852, which contains a wavelength-selective reflector unit that reflects light in the wavelength bands B2 and B3 and transmits light in the wavelength band B1. The wavelength bands passed through the first wavelength pass/drop unit 852 are output along output 858 to the second wavelength pass/drop unit 854. The wavelength band dropped by the first wavelength pass/drop unit 852 is output along the output 860. Thus, the first wavelength pass/drop unit 852 can separate the optical signal in the wavelength band B1 from the other wavelength bands.

The second wavelength pass/drop unit 854 contains a wavelength-selective reflector unit that reflects light in the wavelength bands B1 and B3, and transmits light in the wavelength band B2. The optical signals passed through the second wavelength pass/drop unit 854 are output along output 864, while the optical signal dropped by the second wavelength pass/drop unit 854 is output along output 862. Thus, the second wavelength pass/drop unit can separate the optical signal in the wavelength band B2 from the other wavelength bands.

The appearance of optical signals at different wavelength bands on the different outputs 860, 862, 864 depends on the state of the wavelength pass/drop units 852, 854. The following table shows the wavelength bands of optical signals appearing on the various outputs 860, 862, 864 for the various possible combinations of states of the wavelength pass/drop units 852, 854.

TABLE
Output Logic for Optical Circuit 850

| State of first | State of second | | | |
|---|---|---|---|---|
| wavelength | wavelength | Signal on | Signal on | Signal on |
| pass/drop | pass/drop | first | second | third |
| unit 852 | unit 854 | output 860 | output 862 | output 864 |
| Pass | Pass | n/a | n/a | B1, B2, B3 |
| Pass | Drop | n/a | B2 | B1, B3 |
| Drop | Pass | B1 | n/a | B2, B3 |
| Drop | Drop | B1 | B2 | B3 |

Thus, the optical signals in the various wavelength bands may be separated from each other. It will be appreciated that additional wavelength pass/drop units might be cascaded in a similar manner in order to provide capabilities for separating optical signals in a different number of wavelength bands.

An exemplary application of a wavelength pass/drop unit is shown schematically in FIG. 8D. In this application, an optical network 870 directs an optical signal along a fiber feed 872 to a 1:N splitter 874, which sends the optical signal along user fibers 876 to N different end users 878. The optical signal transmitted to the user fibers 876 includes a first portion in a first wavelength band, B1, that contains information being communicated to the end user. The optical signal may also include a second portion in a second band, B2, used for optical system monitoring and management purposes. For example, the light in the second band, B2 may be used for optical time domain reflectometry (OTDR) for monitoring the integrity of the fiber system assigned to a particular user. A wavelength pass/drop unit 880 is provided on each user fiber 876 and, in normal circumstances, is used to drop the light at the second wavelength band, B2, for example to a drop fiber 882, so that the light at B2 does not reach the end users 878. However, the wavelength pass/drop unit 880 may be reconfigured to allow the light in wavelength band B2 to pass to a specific user when it is desired to do so, e.g. if it is desired to probe the integrity of the fiber connection to a specific end user. In the illustrated embodiment, all of the wavelength pass/drop units 880 are configured to drop the light at wavelength band B2, except for user N−1, in which case the wavelength pass/drop unit 880 for user N−1 is configured to pass the light at wavelength band B2.

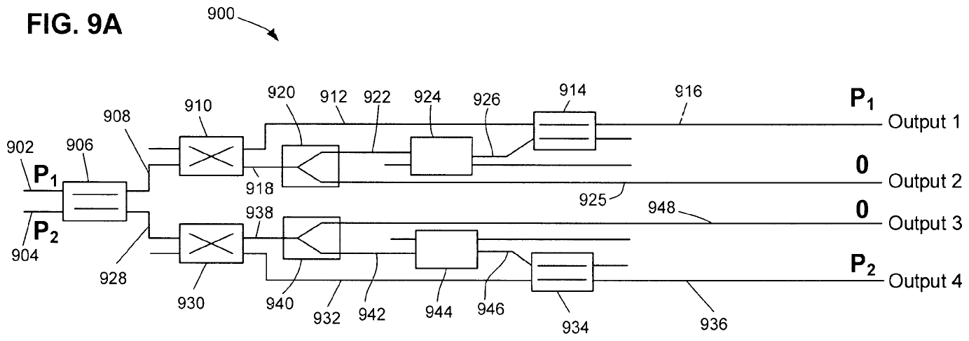

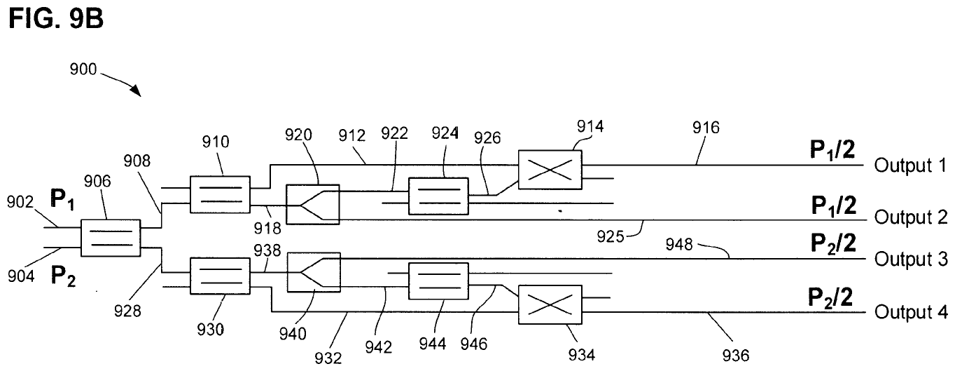

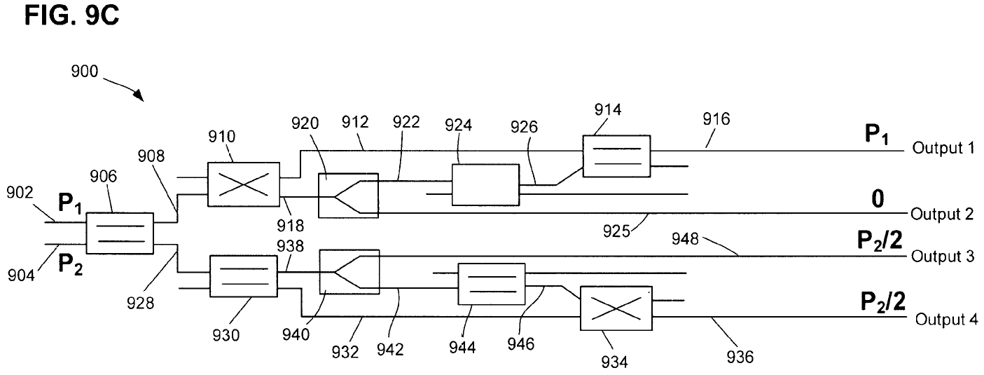

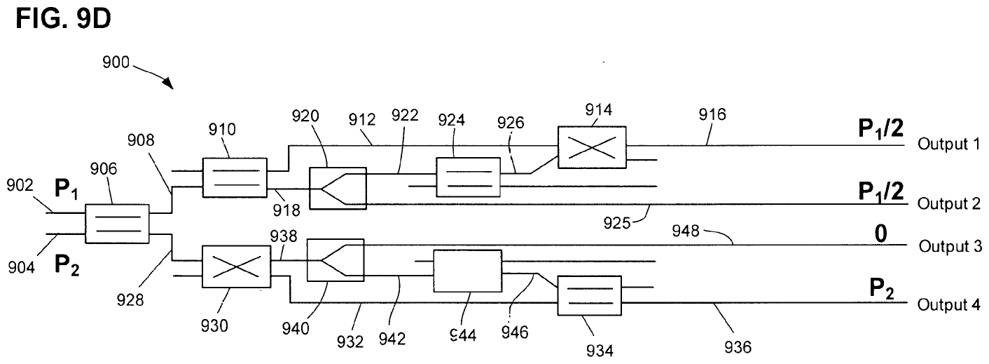

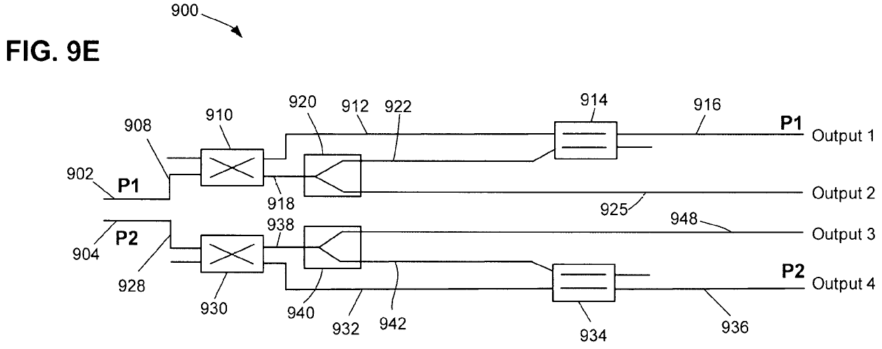

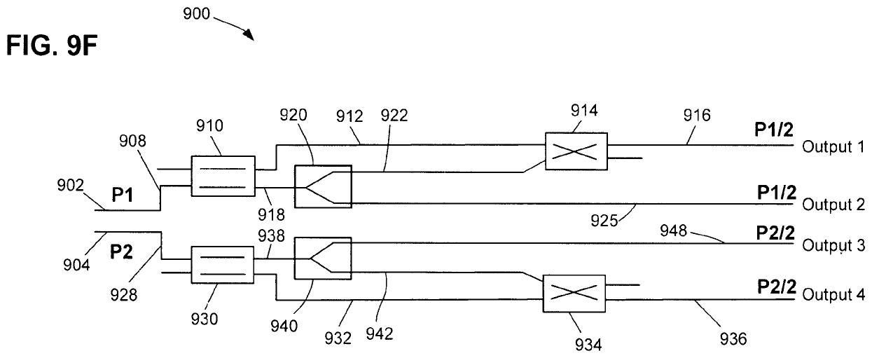

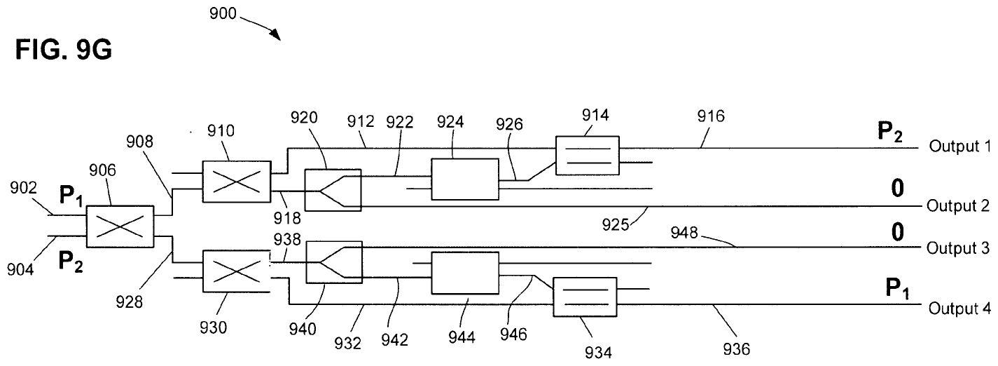

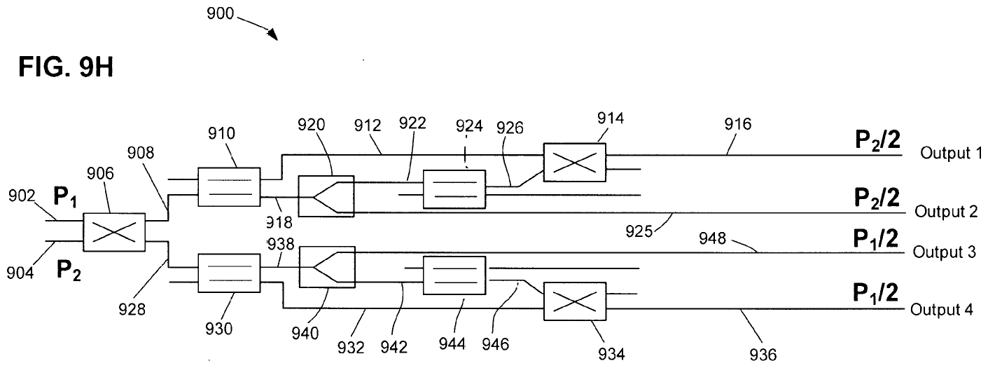

Another embodiment of the present invention relates to a circuit that is effectively a splitter circuit having selectable splitting ratios. One example of a circuit 900 having selectable splitting ratios is schematically illustrated in FIG. 9A. First and second input waveguides 902, 904 are connected to a first TIR optical switch 906. The optical power of the signal propagating along the first waveguide 902 is P1 and the optical power of the signal propagating along the second waveguide is P2. The first output 908 from first TIR switch 906 is directed to a second TIR switch 910. A first output 912 from the second TIR switch 910 is directed as a first input to a third TIR switch 914. When the second TIR switch 910 is in the cross state, the optical signal propagating along the first output 908 is directed by the second TIR switch 910 to its first output 912. Only one output 916 from the third TIR switch 914 is used as a circuit output, Output 1. Light propagating along waveguide 912 into the third TIR switch 914 is passed to the output 916 when the third TIR switch 914 is in the pass state.

The second output 918 from the second TIR switch 910 is input to a first y-branch coupler 920, which may be a 3 dB coupler or an asymmetric coupler. For consideration of the present embodiment, the first y-branch coupler 920 is a 3 dB coupler. The first y-branch coupler 920 has a first output 922 that is coupled as an input to a fourth TIR switch 924. One of the outputs 926 of the fourth TIR switch 924 is coupled as a second input to the third TIR switch 914. The other output 925 from the first y-branch coupler 920 may be used as a circuit output, Output 2.

The lower half of the circuit 900 is the mirror image of the top half. The second output 928 from first TIR switch 906 is directed to a fifth TIR switch 930. A first output 932 from the fifth TIR switch 930 is directed as a first input to a sixth TIR switch 934. When the fifth TIR switch 930 is in the cross state, the optical signal propagating along the second output 928 from the first TIR switch 906 is directed by the fifth TIR switch 930 to its first output 932. Only one output 936 from the sixth TIR switch 934 is used as a circuit output, Output 4. Light propagating along waveguide 932 into the sixth TIR switch 934 is passed to the output 936 when the sixth TIR switch 934 is in the bar state.

The second output 938 from the fifth TIR switch 930 is input to a second y-branch coupler 940, which may be a 3 dB coupler or an asymmetric coupler. For consideration of the present embodiment, the second y-branch coupler 940 is a 3 dB coupler. The second y-branch coupler 940 has a first output 942 that is coupled as an input to a seventh TIR switch 944. One of the outputs 946 of the seventh TIR switch 944 is coupled as a second input to the sixth TIR switch 934. The other output 948 from the second y-branch coupler 940 may be used as a circuit output, Output 3.

In the embodiment shown in FIG. 9A, the second and fifth TIR optical switches 910, 930 are in the cross state. Thus, the light entering the circuit 900 on the first input 902 is output from the second TIR switch 910 to output 912 and the light entering the circuit 900 on the second input 904 is output from the fifth TIR switch 930 to output 932. The third and sixth TIR switches 914, 934 are in the bar state, so the light propagating along waveguide 912 is output along waveguide 916 and the light propagating along waveguide 932 is output along waveguide 936. Thus, in this switch configuration, the signal on first input 902 is directed to waveguide 916 which outputs a signal having a power P1, ignoring switch and propagating losses within the circuit 900. Likewise, the signal on the second input 904 is directed to waveguide 936 which outputs a signal having a power P2.

In this this switch configuration, no optical signal is directed through either the fourth or the seventh TIR optical switches 924, 944, and so their switch states do not affect the output of the circuit 900. Thus, in some embodiments, these switches 924, 944 may be omitted.

In the embodiment of circuit 900 illustrated in FIG. 9B, the second and fifth TIR optical switches 910, 930 are in the bar state, the third and sixth TIR optical switches 914, 934 are in the cross state and the fourth and seventh TIR optical switches 924, 944 shown are in the bar state. With this switch configuration, the light from the second and fifth TIR optical switches 910, 930 is passed respectively to the first and second y-branch couplers 920, 940. In the case where the y-branch couplers 920, 940 are 3 dB couplers, one half of the first signal is split along the waveguides 922 and 925. The light propagating along waveguide 922 is transmitted through the fourth TIR optical switch 924, which is in the bar state, to output 926 which is input to the third TIR optical switch 914. Since optical switch 914 is in the cross state, the signal entering on waveguide 926 is directed to waveguide 916 and is output as Output 1. In the lower half of the circuit 900, the light propagating along waveguide 942 is transmitted through the seventh TIR optical switch 944, which is in the bar state, to output 946 which is input to the sixth TIR optical switch 934. Since optical switch 934 is in the cross state, the signal entering on waveguide 946 is directed to waveguide 936 and is output as Output 4.

In addition, one half of the light entering the first y-branch coupler 920 is output along waveguide 925 to Output 2, and one half of the light entering the second y-branch coupler 940 is output along waveguide 948 to Output 3. Thus, in this switch configuration, the circuit 900 provides P1/2 to each of Outputs 1 and 2 and provides P2/2 to each of Outputs 3 and 4.

The circuit 900 may be configured in other ways, for example, to split light from one of its inputs but not from the other. For example, in FIG. 9C, the second TIR optical switch 910 is in the cross state and the third TIR optical switch 914 is in the bar state, so light propagating along waveguide 908 from the first TIR optical switch 906 bypasses the first y-branch coupler 920 and is directed to Output 1, and no optical signal is directed to Output 2. Also, the fifth TIR optical switch 930 is in the bar state, so light propagating on waveguide 930 is directed to the y-branch coupler. The seventh TIR optical switch 944 is in the bar state and the sixth TIR optical switch 934 is in the cross state, so the light from the y-branch coupler 940 is equally split at Output 3 and Output 4.

In another switch configuration, schematically illustrated in FIG. 9D, the second TIR optical switch 920 and the fourth TIR optical switch are in the bar state while the third TIR optical switch 914 is in the cross state. Therefore, the optical signal entering the first input 902 produces signals at Outputs 1 and 2 of equal strength. Also, the fifth TIR optical switch 930 is in the cross state and the sixth TIR optical switch 934 is in the bar state, so light propagating along waveguide 928 from the first TIR optical switch 906 bypasses the second y-branch coupler 940 and is directed to Output 4, and no optical signal is directed to Output 3.

FIG. 9G schematically illustrates another switch configuration of the optical circuit 900. This configuration is the same as shown in FIG. 9A, except that the first optical switch 906 is in the cross state, rather than the bar state. Consequently, the signal P1 is received at Output 4 and the signal P2 is received at Output 1. Likewise, FIG. 9H schematically illustrates another switch configuration of the optical circuit 900. This configuration is the same as shown in FIG. 9B, except that the first optical switch 906 is in the cross state, rather than the bar state. Consequently, the signal P1 is split into two parts at y-branch coupler 940 so that a signal of P1/2 is received at Output 3 and at Output 4. The signal P2 is split into two parts at the y-branch coupler 920, so that a signal of P2/2 is received at Output 1 and at Output 2.

It will be appreciated that there may be variations on the selective splitter circuit 900 shown in FIGS. 9A-9D, 9G and 9H. For example, the first TIR optical switch 906 may be omitted. In addition, the fourth and/or seventh TIR optical switches 924, 944 may be omitted, and replaced by waveguides. In other embodiments, the y-branch couplers may be asymmetric couplers.

A variation of the selective splitter circuit 900, schematically illustrated in FIGS. 9E and 9F, omits the first TIR optical switch 906 and the fourth and seventh TIR optical switches 924, 944. Thus, the first output 922 from the first y-branch coupler 920 is coupled into the third TIR optical switch 914 while the second output 925 from the first y-branch coupler 920 is used as Output 2. Likewise, in this switch state, the first output 942 from the second y-branch coupler 940 is coupled into the sixth TIR optical switch 934 while the second output 948 from the second y-branch coupler 940 is used as Output 3. FIG. 9E shows the configuration of the optical switches 910, 914, 930 and 934 to produce an output of P1 at Output 1 and an output of P2 at Output 4, while FIG. 9F shows the configuration of the optical switches 910, 914, 930 and 934 to produce an output of P1/2 at Outputs 1 and 2, and an output of P2/2 at Outputs 3 and 4.

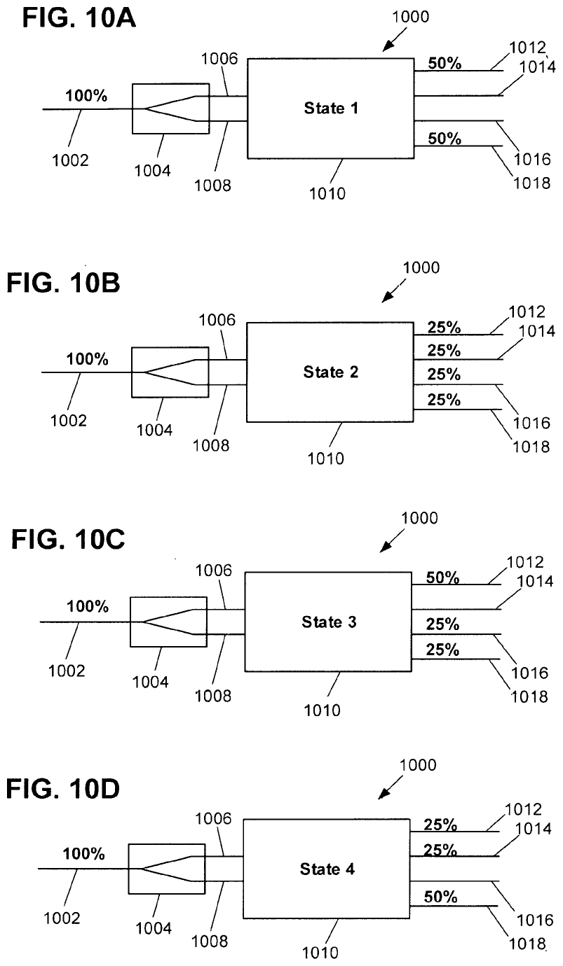

A selective splitter circuit as discussed above may be used a basic building block for a larger circuit that provides more splitting ratio options. FIG. 10A schematically illustrates a selective splitter circuit 1000 that has a single input 1002 that is split into two at a y-branch coupler 1004. The two outputs 1006, 1008 from the y-branch coupler are fed into a basic selective splitter circuit 1010 that is similar to the optical circuit described above with regard to FIGS. 9A-9D. The basic selective splitter circuit 1010 has four outputs 1012, 1014, 1016, 1018. When the basic selective splitter circuit 1010 is in state 1, corresponding to the circuit configuration of the basic selective splitter circuit shown in FIG. 9A, the optical circuit 1000 produces signals of equal magnitude at outputs 1012 and 1018. When the basic selective splitter circuit 1010 is in state 2, as shown in FIG. 10B, corresponding to the configuration of the basic selective splitter circuit shown in FIG. 9B, the optical circuit 1000 produces signals of equal magnitude at all four outputs 1012, 1014, 1016, 1018. When the basic selective splitter circuit 1010 is in state 3 as shown in FIG. 10C, corresponding to the configuration of the basic selective splitter circuit shown in FIG. 9C, the optical circuit 1000 produces a signal having one half of the incoming signal power on output 1012 and signals having one quarter of the incoming signal power on outputs 1016 and 1018. When the basic selective splitter circuit 1010 is in state 4 as shown in FIG. 10D, corresponding to the configuration of the basic selective splitter circuit shown in FIG. 9D, the optical circuit 1000 produces a signal having one half of the incoming signal power on output 1018 and signals having one quarter of the incoming signal power on outputs 1012 and 1014.

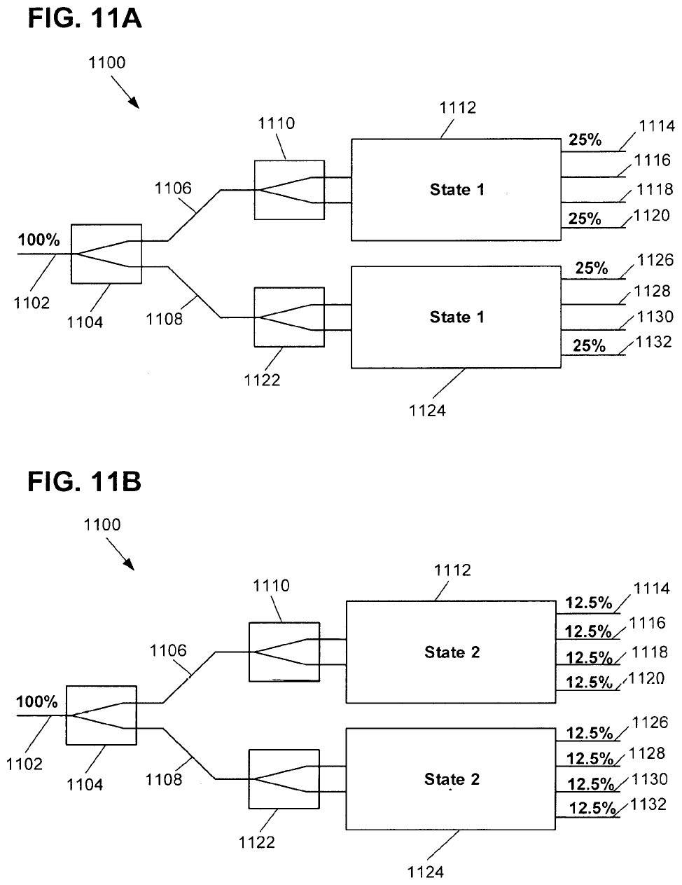

A further example of an optical circuit 1100, configured with two basic selective splitter circuits operating in parallel, is shown in FIGS. 11A and 11B. The optical circuit 1100 has an input 1102 that feeds into a first y-branch coupler 1104, having two outputs 1106, 1108. The first output 1106 is fed into a second y-branch coupler 1110. The two outputs from the second y-branch coupler 1110 are fed into a first basic selective splitter circuit 1112, having four outputs 1114, 1116, 1118, 1120. The second output 1108 from the first y-branch coupler 1104 is fed into a third y-branch coupler 1122. The two outputs from the third y-branch coupler 1122 are fed into a second basic selective splitter circuit 1124, having four outputs 1126, 1128, 1130, 1132. When the basic selective splitter circuits 1112, 1124 are each in State 1, they each produce two output signals having the same power. The first basic selective splitter circuit 1112 produces signals on outputs 1114 and 1120, each optical signal containing around 25% of the optical power input at 1102. The second basic selective splitter circuit 1124 produces signals on outputs 1126 and 1132, each optical signal containing around 25% of the optical power input at 1102. Thus, the optical circuit 1100 operates as a 1:4 optical splitter.

In FIG. 11B, the basic selective splitter circuits 1112, 1124 are each in State 2, in which case each basic selective splitter circuit 1112, 1124 provides optical signals of equal power to each of its four outputs 1114, 1116, 1118, 1120 and 1126, 1128, 1130 1132 respectively. Thus, by changing the states of the switches in the basic selective splitter circuits 1112, 1124, the optical circuit 1100 operates is converted from a 1:4 optical splitter to a 1:8 optical splitter.

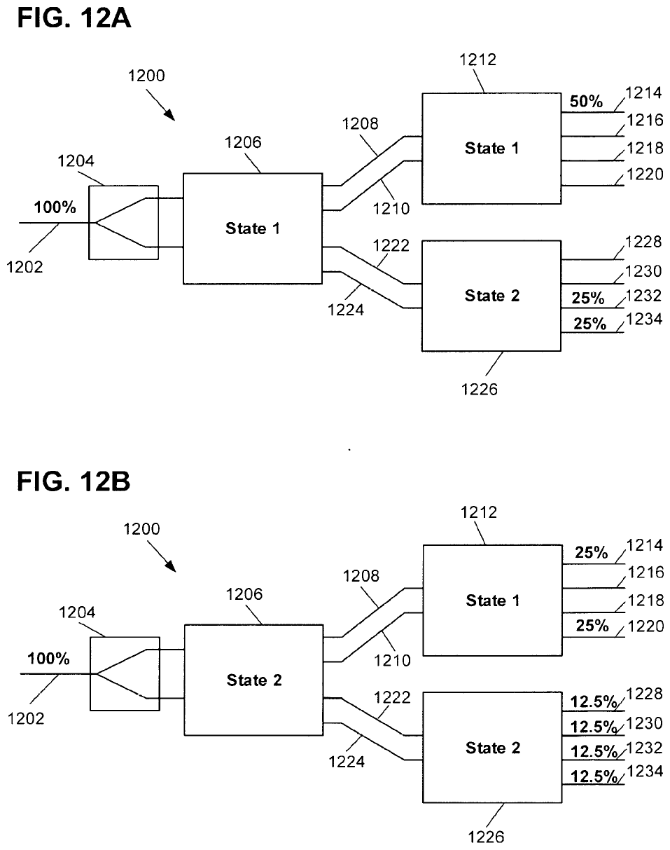

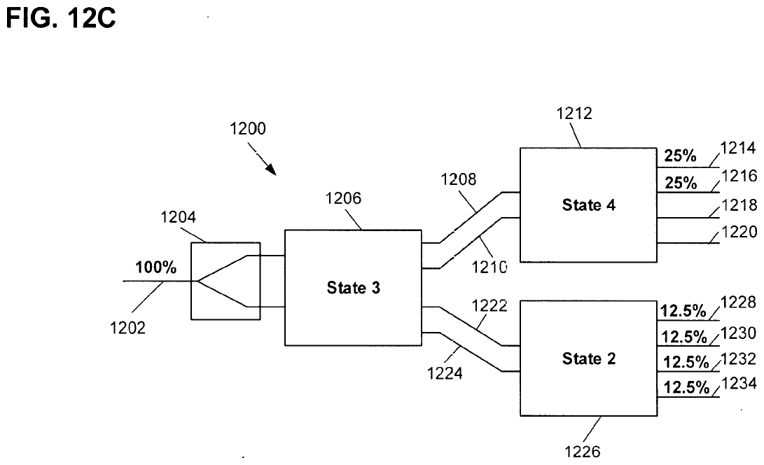

Another example of optical circuit 1200 that can be built using two stages of basic selective splitter circuits is schematically illustrated in FIG. 12A. In this optical circuit 1200, an input 1202 is fed into a y-branch coupler 1204, the outputs from which are fed into a first basic selective splitter circuit 1206. Two outputs 1208, 1210 from the first basic selective splitter circuit 1206 are fed into a second basic selective splitter circuit 1212, which has four outputs 1214, 1216, 1218, 1220. Two other outputs 1222, 1224 from the first basic selective splitter circuit 1206 are fed into a third basic selective splitter circuit 1226, which has four outputs 1228, 1230, 1232, 1234.

In the illustrated configuration, the first basic selective splitter circuit 1206 is in State 1, and so 50% of the input optical signal is transmitted along waveguide 1208 and 50% is transmitted along waveguide 1224. The second basic selective splitter circuit 1212 is in State 1, so the power entering along waveguide 1208 is transmitted to output 1214. The third basic selective splitter circuit 1226 is in State 2, so the power entering along waveguide 1224 is split evenly between outputs 1232 and 1234.

A different configuration of the optical circuit 1200 is shown in FIG. 12B, with both the first and third basic selective splitter circuits 1206 and 1226 being in State 2, while the second basic selective splitter circuit 1212 is in State 1. Thus, because it the first basic selective splitter circuit 1206 is in State 2, the optical power entering the first basic selective splitter circuit 1206 is split evenly among all four outputs 1208, 1210, 1222, 1224. Because the second basic selective splitter circuit 1212 is in State 1, the optical power propagating along waveguides 1208, 1210 is passed to outputs 1214 and 1220 respectively, so these outputs both carry a signal having a power that is 25% of the signal input to waveguide 1202. Because the third basic selective splitter circuit 1226 is in State 2, the optical power entering along waveguide 1222 is split evenly between outputs 1228 and 1230, while the power entering along waveguide 1224 is split evenly between outputs 1232 and 1234. Thus, in this configuration, outputs 1214 and 1220 each carry a signal having 25% of the optical power input to the circuit 1200, while outputs 1228, 1230, 1232 and 1234 each carry an optical signal carrying 12.5% of the optical power input to the optical circuit 1200.

Another configuration of the optical circuit 1200 is shown in FIG. 12C, with the first basic selective splitter circuit 1206 in State 3, the second basic selective splitter circuit 1212 in State 4 and the third basic selective splitter circuit in State 2. Because the first basic selective splitter circuit 1206 is in State 3, the output waveguide 1208 carries an optical signal having 50% of the input power carried by the input waveguide 1202, while the output waveguides 1222, 1224 each carry an optical signal having 25% of the optical power of the input waveguide 1202. Because it is in State 4, the second basic selective splitter circuit 1212 evenly splits the optical power input via waveguide 1208 between the output waveguides 1214 and 1216, so they each carry 25% of the optical power input to the circuit 1200. Because it is in State 2, the third basic selective splitter circuit 1226 evenly splits the optical power input via waveguide 1222 between outputs waveguides 1228 and 1230, and evenly splits the optical power input via waveguide 1224 between the output waveguides 1232 and 1234. Therefore, each of the outputs 1228, 1230, 1232, 1234 from the second basic selective splitter circuit 1226 carries 12.5% of the optical power input to the circuit 1200. In this configuration, the optical signals at the outputs 1214-1220 and 1228-1234 would be the same if the second basic selective splitter circuit 1212 is in State 2, because the first basic selective splitter circuit 1206 sends no light along output 1210 to feed light into outputs 1218 and 1220.

It will be appreciated that the optical power in the various outputs from the optical circuit 1200 can be varied by selecting the states of the various basic selective splitter circuits.

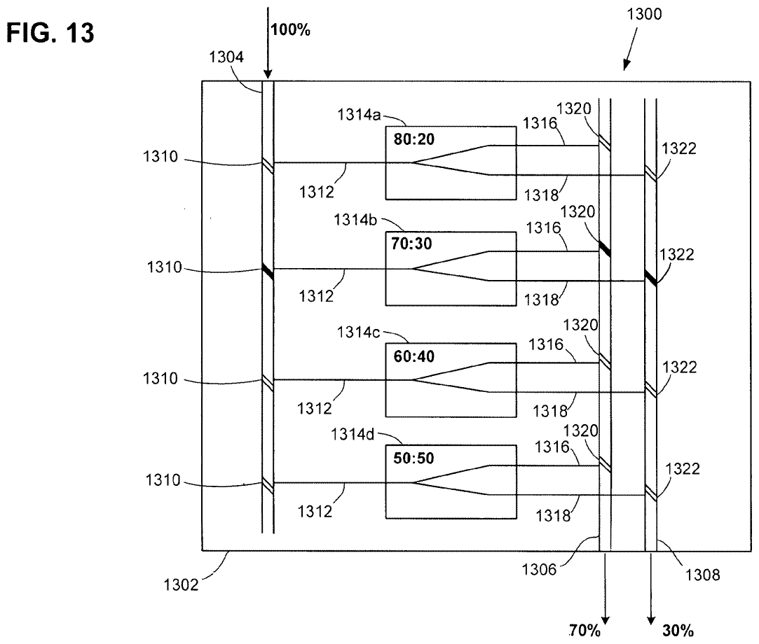

Another approach for an optical splitter 1300 having a tunable splitting ratio is schematically illustrated in FIG. 13. The tunable optical splitter 1300, formed on a substrate 1302, has an input waveguide 1304 and two output waveguides 1306, 1308. The input waveguide 1302 is provided with a sequential series of TIR optical switches 1310 that lead to respective switch output waveguides 1312. Each switch output waveguide 1312 is coupled to a respective y-branch coupler 1314a-1314d. The y-branch couplers 1314a-1314d have different splitting ratios: for example in the illustrated embodiment y-branch coupler 1314a has an 80:20 splitting ratio, y-branch coupler 1314b has a 70:30 splitting ratio, y-branch coupler 1314c has a 60:40 splitting ratio and y-branch coupler 1314d has a 50:50 splitting ratio. Each y-branch coupler 1314a-1314d has respective first and second splitter outputs 1316, 1318. Each first splitter output 1316 leads to a respective TIR optical switch 1320 on the first output waveguide 1304 and each second splitter output 1318 leads to a respective TIR optical switch 1322 on the second output waveguide 1306.

Each y-branch coupler 1314 has associated with it a TIR switch 1310 on the input waveguide 1304 that directs light from the input waveguide 1304 to the respective y-branch coupler 1314. Also, each y-branch coupler 1314 has an associated TIR optical switch 1320 on the first output waveguide 1306 and an associated TIR optical switch 1322 on the second output waveguide 1306. When it is desired to split the incoming optical signal using a ratio of one of the y-branch couplers 1314, the TIR switches 1310, 1320, 1322 associated with that particular y-branch coupler 1314 are set to the cross (reflective) state, while all other TIR switches that the optical signal has to pass through are set to the bar (transmissive) state. In the illustrated embodiment, the optical signal is split at a ratio of 70:30, so the TIR optical switch 1310 associated with the second y-branch coupler 1314b is set to reflect the optical signal from the input waveguide 1304 to the 70:30 y-branch coupler 1314b.

It will be appreciated that the tunable optical splitter 1300 may include y-branch couplers having splitting ratios different from those shown in the exemplary embodiment, and may also include a different number of y-branch couplers. While it is important that the TIR optical switches that the optical signals pass through are in a transmissive state, the state of the TIR optical switches through which the optical signals do not pass is not important. For example, in the illustrated embodiment, the second TIR switch 1310 along the input waveguide 1304 is in the reflective state. Accordingly, the first TIR switch 1310 along the input waveguide 1304 has to be in the transmissive state for the optical signal to reach the second TIR optical switch 1310. However, the state of the third and fourth TIR optical switches 1310 on the input waveguide 1304 is unimportant, as the optical signal does not reach these switches before being reflected output of the input waveguide to a y-branch coupler 1314. Therefore, the third and fourth TIR switches on the input waveguide 1304 may be either in the reflective or transmissive state. Likewise, once reaching the first and second output waveguides 1306, 1308, the optical signals do not pass through the first TIR optical switches 1320, 1322 associated with y-branch coupler 1314a, so the state of these switches is not important. Thus, the first TIR switches 1320, 1322 may be in either the reflective or transmissive state.

While various examples were provided above, the present invention is not limited to the specifics of the examples. For example, various combinations of elements shown in different figures may be combined together in various ways to form additional optical circuits not specifically described herein. It is intended that the invention cover certain embodiments of the optical circuits discussed above in which all of the optical switches in a circuit are TIR EWOD optical switches.

As noted above, the present invention is applicable to fiber optical communication and data transmission systems. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What we claim as the invention is:

1. An optical circuit, comprising:
a first input waveguide;
at least a first output waveguide;
an optical path between the first input waveguide and the at least a first output waveguide;
a first totally internally reflecting (TIR) optical switch on the optical path between the first input waveguide and the at least a first output waveguide; and
a wavelength selective filter disposed on the optical path between the first input waveguide and the at least one output waveguide, the wavelength selective filter being transmissive for light in a first wavelength range and reflective for light in a second wavelength range.

2. An optical circuit as recited in claim 1, further comprising a second TIR optical switch, a first output from the first TIR optical switch arranged to propagate light received from the first input waveguide to the wavelength selective filter, a second output from the first TIR optical switch arranged to propagate light from the first TIR optical switch to the second TIR optical switch, a second output waveguide coupled to receive light from an output of the second TIR optical switch.

3. An optical circuit as recited in claim 2, wherein the first output waveguide is disposed to receive light transmitted through the wavelength selective filter and wherein light reflected by the wavelength selective filter is directed to the second TIR optical switch.

4. An optical circuit as recited in claim 3, wherein the wavelength selective filter is capable of selecting light in a first wavelength band from light in a second wavelength band, when light in the first wavelength band and in the second wavelength band is propagated along the first input waveguide to the first TIR optical switch, light in both the first and the second wavelength bands propagates along the second output waveguide when the first TIR optical switch is in a first switch state and the second TIR optical switch is in a first switch state, and light in the first wavelength band propagates along the first output waveguide and light in the second wavelength band propagates along the second output waveguide when the first TIR optical switch is in a second switch state and the second TIR optical switch is in a second switch state.

5. An optical circuit as recited in claim 4, wherein the first switch state of the first TIR optical switch is a cross state, the first switch state of the TIR optical switch is a bar state, the second switch state of the first TIR optical switch is a bar state, and the second switch state of the TIR optical switch is a cross state.

6. An optical circuit as recited in claim 1, wherein the first TIR optical switch is a TIR electro-wetting on dielectric (EWOD) optical switch.

7. An optical circuit, comprising:
a first wavelength pass/drop unit comprising
an input coupled to a first totally internally reflecting (TIR) optical switch,
a first output from the first TIR optical switch coupled to a first wavelength selective filter,
an output from the wavelength selective filter comprising a first output of the first wavelength pass/drop unit,
a second output from the first TIR optical switch coupled as a first input to a second TIR optical switch,
a second output from the first wavelength selective filter being coupled as a second input to the second TIR optical switch, and
an output from the second TIR optical switch comprising a second output from the first wavelength pass/drop unit; and
a second wavelength pass/drop unit comprising
an input coupled to a third TIR optical switch,
a first output from the third TIR optical switch coupled to a second wavelength selective filter,
an output from the second wavelength selective filter comprising a first output of the second wavelength pass/drop unit output,
a second output from the third EWOD optical switch coupled as a first input to a fourth TIR optical switch,
a second output from the second wavelength selective filter being coupled as a second input to the fourth TIR optical switch, and
an output from the fourth TIR optical switch comprising a second output of the second wavelength pass/drop unit;
wherein the second output of the first wavelength pass/drop unit is coupled as the input to the third TIR optical switch of the second wavelength pass/drop unit.

8. An optical circuit as recited in claim 7, wherein the first wavelength selective filter is capable of selecting light in a first wavelength band from light in a second wavelength band and light in a third wavelength band.

9. An optical circuit as recited in claim 8, wherein the second wavelength selective filter is capable of selecting light in the second wavelength band from light in the first wavelength band and light in the third wavelength.

10. An optical circuit as recited in claim 7, wherein the first wavelength selective filter is capable of selecting light in a first wavelength band from light in a second wavelength band and light in a third wavelength band and, when light in the first wavelength band is propagated along the first input to the first TIR optical switch, the light in the first wavelength band propagates along the first output of the first wavelength pass/drop unit when the first TIR optical switch is in a first switch state and the second TIR optical switch is in a first switch state and propagates along the second output of the first wavelength pass/drop unit when the first TIR optical switch is in a second switch state and the second TIR optical switch is in a second switch state.

11. An optical circuit as recited in claim 10, wherein the first switch state of the first TIR optical switch is a bar state and the first switch state of the second TIR optical switch is a cross state.

12. An optical circuit as recited in claim 7, wherein the first, second third and fourth TIR optical switches are TIR electro-wetting on dielectric (EWOD) optical switches.

13. An optical circuit, comprising:
a first wavelength pass/drop unit comprising
an input coupled to a first TIR optical switch,
a first output from the first TIR optical switch coupled to a first wavelength selective filter,
a second output from the first TIR optical switch coupled as a first input to a second TIR optical switch,
an output from the first wavelength selective filter being coupled as a second input to the second TIR optical switch, and
an output from the second TIR optical switch comprising an output from the first wavelength pass/drop unit coupled to a first end user; and
a second wavelength pass/drop unit comprising
an input coupled to a third TIR optical switch,
a first output from the third TIR optical switch coupled to a second wavelength selective filter,
a second output from the third TIR optical switch coupled as a first input to a fourth TIR optical switch,
an output from the second wavelength selective filter being coupled as a second input to the fourth TIR optical switch, and
an output from the fourth TIR optical switch comprising an output of the second wavelength pass/drop unit coupled to a second end user;
the first and second wavelength pass/drop units receiving respective optical signals from an optical splitter, the respective optical signals each comprising an optical signal in a first wavelength band and an optical signal in a second wavelength band;
wherein, when the first wavelength pass/drop unit is in a first state, the output from the first wavelength pass/drop unit coupled to the first end user carries an optical signal in the first wavelength band only and when the first wavelength pass/drop unit is in a second state, the output from the first wavelength pass/drop unit coupled to the first end user carries optical signals in both the first and second wavelength bands.

14. An optical circuit as recited in claim 13, wherein when the second wavelength pass/drop unit is in a first state, the output from the second wavelength pass/drop unit coupled to the second end user carries an optical signal in the first wavelength band only and when the second wavelength pass/drop unit is in a second state, the output from the second wavelength pass/drop unit coupled to the second end user carries optical signals in both the first and second wavelength bands.

15. An optical circuit as recited in claim 13, wherein the first wavelength selective filter is capable of selecting light in a first wavelength band from light in a second wavelength band and, when light in the first wavelength band is propagated along the first input to the first TIR optical switch, the light in the first wavelength band propagates along the first output of the first wavelength pass/drop unit when the first TIR optical switch is in a first switch state and the second TIR optical switch is in a first switch state and propagates along the second output of the first wavelength pass/drop unit when the first TIR optical switch is in a second switch state and the second TIR optical switch is in a second switch state.

16. An optical circuit as recited in claim 13, wherein the first switch state of the first TIR optical switch is a bar state and the first switch state of the second TIR optical switch is a cross state.

17. An optical circuit as recited in claim 13, wherein the first, second, third and fourth TIR optical switches are TIR electro-wetting on dielectric (EWOD) optical switches.

18. A tunable optical splitter circuit comprising:
an input waveguide having an input end and
a first plurality of totally internally reflecting (TIR) optical switches disposed along the input waveguide;
a first output waveguide;
a second output waveguide; and
a plurality of selectable optical paths between the input waveguide and both the first and second output waveguides, each selectable optical path including a y-branch coupler, the y-branch coupler in each selectable optical path being capable of directing a portion of light input to input waveguide into each of the first and second output waveguides, a ratio of optical power of light directed in the first and second output waveguides being dependent on the selected optical path;
wherein a switch state of a selected one of the first plurality of TIR optical switches determines which optical path light propagates along from the input waveguide to the first and second output waveguides.

19. A tunable optical splitter circuit as recited in claim 18, further comprising a second plurality of totally internally reflecting (TIR) optical switches disposed on the first output waveguide to receive a respective optical signal from a first splitter output of a respective one of the plurality of y-branch couplers and a third plurality of a plurality of switch output waveguides coupled between an output of a respective TIR optical switch of the first plurality of TIR optical switches and an input to a respective y-branch coupler, wherein switch states of selected ones of the first plurality of TIR optical switches and the second plurality of TIR optical switches determines which optical path light propagates along from the input waveguide to the first and second output waveguides.

20. A tunable optical splitter circuit as recited in claim 18, wherein optical switches of the first plurality of TIR optical switches are TIR electro-wetting on dielectric (EWOD) optical switches.

21. An optical circuit having a selectable output, comprising:
a first input coupled to receive a first optical signal;
a first intermediate optical circuit coupled to the first input, the first intermediate circuit having first and second intermediate circuit outputs, the first intermediate circuit having a first state and a second state, the first intermediate circuit directing the first optical signal only to the first intermediate circuit output when in the first state, the first intermediate circuit directing a first portion of the first optical signal to the first intermediate circuit output and a second portion of the first optical signal to the second intermediate circuit output when in the second state;
a second input coupled to receive a second optical signal; and
a second intermediate optical circuit coupled to the second input, the second intermediate circuit having third and fourth intermediate circuit outputs, the second intermediate circuit having a first state and a second state, the second intermediate circuit directing the second optical signal only to the fourth intermediate circuit output when in the first state, the second intermediate circuit directing a first portion of the second optical signal to the fourth intermediate circuit output and a second portion of the second optical signal to the third intermediate circuit output when in the second state.

22. An optical circuit as recited in claim 21, further comprising a circuit input coupled to a first y-branch coupler, a first output from the y-branch coupler coupled to the first input and a second output from the y-branch coupler coupled to the second input.

23. An optical circuit as recited in claim 21, wherein the first intermediate circuit comprises a first TIR optical switch arranged to receive the first optical signal, a first output from the first TIR optical switch coupled to a second y-branch coupler, a first output of the second y-branch coupler coupled as a first input to a second TIR optical switch, a second output of the second y-branch coupler comprising the second intermediate circuit output and a second output from the first TIR optical switch coupled as a second input to the second TIR optical switch, an output from the second TIR optical switch comprising the first intermediate circuit output.

24. An optical circuit as recited in claim 23, wherein the second intermediate circuit comprises a third TIR optical switch arranged to receive the second optical signal, a first output from the third TIR optical switch coupled to a third y-branch coupler, a first output of the third y-branch coupler coupled as a first input to a fourth TIR optical switch, a second output of the third y-branch coupler comprising the third intermediate circuit output and a second output from the third TIR optical switch coupled as a second input to the fourth TIR optical switch, an output from the fourth TIR optical switch comprising the fourth intermediate circuit output.

25. An optical circuit as recited in claim 21, wherein the first portion of the first optical signal is substantially equal in magnitude to the second portion of the first optical signal and the first portion of the second optical signal is substantially equal in magnitude to the second portion of the second optical signal.

26. An optical circuit as recited in claim 21, further comprising a fifth TIR optical switch having a first output and a second output, the first output of the fifth TIR optical switch coupled to the first input and a second output of the fifth TIR optical switch coupled to the second input.

27. An optical circuit as recited in claim 26, further comprising a circuit input coupled to a first y-branch coupler, a first output from the y-branch coupler coupled to a first input of the fifth TIR optical switch and a second output from the y-branch coupler coupled to a second input of the fifth TIR optical switch.

28. An optical circuit as recited in claim 21, wherein the first TIR optical switch is a first TIR electro-wetting (EWOD) optical switch and the second TIR optical switch is a second TIR EWOD optical switch.

29. A tunable optical splitter, comprising:
a first basic splitting circuit comprising
a first input to receive a first input optical signal; and
a first switchable optical circuit coupled to receive the input optical signal from the first input, the first switchable optical circuit having first, second, third and fourth outputs; the switchable optical circuit having an input splitter stage that splits the first input optical signal into first and second input signal portions;
wherein the first switchable optical circuit comprises a switchable first intermediate circuit that either directs substantially all of the first input signal portion to the first output or splits the first input signal portion between the first and second outputs, and a switchable second intermediate circuit that either directs substantially all of the second input signal portion to the fourth output or splits the second input signal portion between the third and fourth outputs.

30. A tunable optical splitter as recited in claim 29, further comprising a second basic splitting circuit having a second input to receive a second input optical signal and a second switchable optical circuit coupled to receive the input optical signal from the second input, the switchable optical circuit having fifth, sixth, seventh and eighth outputs; the second switchable optical circuit having an input splitter stage that splits the second input optical signal into third and fourth input signal portions, wherein the second switchable optical circuit comprises a switchable third intermediate circuit that either directs substantially all of the third input signal portion to the fifth output or splits the third input signal portion between the fifth and sixth outputs, and a switchable fourth intermediate circuit that either directs substantially all of the fourth input signal portion to the eighth output or splits the fourth input signal portion between the seventh and eighth outputs, and an input splitter circuit having an input splitter input, a first input splitter output coupled to the first input of the first basic splitting circuit and a second input splitter output coupled to the second input of the second basic splitting circuit.

31. A tunable optical splitter as recited in claim 30, wherein the input splitter circuit comprises a y-branch coupler.

32. A tunable optical splitter as recited in claim 30, wherein the input splitter circuit comprises a first passive splitter having a first passive splitter output and a second passive splitter output.

33. A tunable optical splitter as recited in claim 32, wherein the input splitter stage of the first basic splitting circuit comprises a first active intermediate splitter circuit that either directs a first optical signal from the first passive splitter output substantially all to the first input of the first basic splitting circuit as the first input portion, or splits the optical signal from the first passive splitter output between the first and second inputs of the first basic splitting circuit as the first and second input portions, and
wherein the input splitter stage of the second basic splitting circuit comprises a second active intermediate splitter circuit that either directs a second optical signal from the second passive splitter output substantially all to the fourth input of the second basic splitting circuit as the fourth input portion, or splits the second optical signal from the second passive splitter output between the third and fourth inputs of the second basic splitting circuit as the third and fourth input portions respectively.

34. A tunable optical splitter as recited in claim 33, further comprising a third basic splitting circuit, the third basic splitting circuit comprising the first active intermediate splitter circuit and the second active intermediate splitter circuit.
